(19) United States
(12) Patent Application Publication
(10) Pub. No.: US 2013/0089335 A1
(43) Pub. Date: Apr. 11, 2013

(54) IR protocol for 3D active eyewear

(71) Applicants: Douglas J. Gorny, Boulder, CO (US); Roger Landowski, Erie, CO (US); Greg Graham, Boulder, CO (US); Anthony Palazzolo, Erie, CO (US)

(72) Inventors: Douglas J. Gorny, Boulder, CO (US); Roger Landowski, Erie, CO (US); Greg Graham, Boulder, CO (US); Anthony Palazzolo, Erie, CO (US)

(73) Assignee: REALD INC., Beverly Hills, CA (US)

(21) Appl. No.: 13/435,227

(22) Filed: Mar. 30, 2012

Related U.S. Application Data
(60) Provisional application No. 61/469,689, filed on Mar. 30, 2011.

(51) Int. Cl. H04B 10/114

(52) U.S. Cl. CPC H04B 10/114
USPC 398/106

(57) ABSTRACT

A method is provided for receiving information in the form of a command sequence. The command sequence may include shutter timing information and at least one command from a set of four commands. The commands within the command sequence may indicate different functions and may depend on at least the relative timing location to one another, the quantity of each command in the command sequence and the order of the commands relative to one another. Additionally, at least one command of the set of four commands may be received after the function should occur. A receiver may receive a signal which may include at least the command sequence. Once the receiver has received the same command sequence a couple of times, an operating mode may be determined which may allow additional commands to be implied, even though the additional commands may not actually be received by the receiver.

### CROSS-REFERENCE TO RELATED APPLICATIONS

This application claims priority to U.S. Provisional Patent Application Ser. No. 61/469,689, filed Mar. 30, 2011, entitled “IR protocol for 3D active eyewear,” the entirety of which is herein incorporated by reference

### TECHNICAL FIELD

This disclosure generally relates to shutter glasses and, more specifically, relates to a schema for shutter glass eyewear control.

### BACKGROUND

Shuttering eyewear (or shutter glasses) can be used to enable stereoscopic 3D and to provide different images to two viewers using a single display, which is known as dual view. These devices utilize an infrared (IR) signal generated by an infrared emitter which is synchronized to the display often by receiving from the display a signal compliant with Video Electronics Standard Association (VESA) Standard Connector and Signal Standards for Stereoscopic Display Hardware, Version 1, Nov. 5, 1997 (“VESA Standards”), which are herein incorporated by reference. Emitters typically output a very simple pulse width modulated signal to indicate which eye to activate.

The eyewear responds by performing a hard-coded sequence of switching events which open and close the eyewear shutters in order to achieve the desired visual effect. The hard-coded switching sequence is generally either a compromising solution which provides acceptable performance for a set of displays or an optimized solution which is optimized (hard-coded) for a single display.

Due to the use of low cost assembly techniques, dense circuitry, high surge current used to switch the shutters, and low power design techniques, shuttering eyewear creates an electrically noisy environment in which the processing logic operates. When used with the pulse width modulation technique, the switching point for the shutters is typically at or very near the transition point of the infrared sync signal. This may limit the sensitivity of the infrared detector and, thus, may limit the infrared detector's ability to differentiate between system noise and the infrared signal.

### BRIEF SUMMARY

According to the present disclosure, a method for conveying information to a receiver may include providing a command sequence, in which the command sequence may include shutter timing information and the command sequence may include at least one command of a set of commands, and further, the commands may indicate different functions depending on a timing location. The method may further include enabling an emitter to emit a signal containing at least the command sequence. The commands may indicate different functions depending on the order of the commands relative to one another and on the quantity of each command included in the command sequence. The command sequence may define an operating mode for shutter eyewear, in which the operating mode may be assumed to be stable after at least two command sequences. The method may include defining the time between lens actions and commands as a fraction of a lens sequence period and defining the time between lens actions and commands may include measuring the lens sequence period between the centers of commands for all but non-symmetric modes. Additionally, the method may remove dependency on real time counting in the shutter timing information and may provide the signal as an infrared signal. Moreover, the method may include substantially removing timing holes in the duty cycle and period options due to command timing restrictions.

According to another aspect of the present disclosure, a method for receiving information from an emitter, may include receiving a command sequence that may include shutter timing information, in which the command sequence may include at least one command of a set of commands, and further, the commands may indicate different functions depending on a timing location and at least one command of the set of commands may be received after the function should occur. The method may also include enabling a receiver to receive a signal including at least the command sequence. The commands may indicate different functions depending on the order of the commands relative to one another within the command sequence and on the quantity of each command included in the command sequence. The command sequence may be received by shutter eyewear and the command sequences may define an operating mode for the shutter eyewear. The method may further include defining the time between lens actions and commands as a fraction of a lens sequence period, and in which defining the time between lens actions and commands may include measuring the lens sequence period between the centers of commands for all but non-symmetric modes. Further, the method may include removing dependency on real time counting in the shutter timing information, in which the lens sequence period may not be a fixed time, and also may include determining an operating mode after receiving more than two cycles of command sequences. Moreover, the method may include continuing the operating mode after determining the operating mode by assuming the operating mode may remain substantially stable.

According to yet another aspect of the present disclosure, a shutter timing protocol for conveying information may include a set of commands in which at least one of the commands may be received after the function should be performed, and may also include a command sequence which may include at least one of the commands of the set of commands, in which the commands may indicate different functions to be performed depending on the quantity of each command within the command sequence and depending on the timing location of the command within the command sequence. The command sequence may substantially remove timing holes in the duty cycle and period options due to command timing restrictions.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying figures, in which like reference numbers indicate similar parts, and in which:

FIG. 1 is a schematic diagram of a shutter glass eyewear system;

FIG. 2 is a schematic diagram of one embodiment of a signal emitting system;

FIG. 3 is a schematic diagram of another embodiment of a signal receiving system;

FIG. 4 is one embodiment of a table of command encodings, in accordance with the present disclosure;

FIG. 5 is a timing table and diagram for one embodiment of an operational mode, in accordance with the present disclosure;

FIG. 6 is a schematic diagram of another embodiment of an operational mode, in accordance with the present disclosure;

FIG. 7 is a timing illustration of command sequences and resulting implied modes of operation for one embodiment of an operational mode, in accordance with the present disclosure;

FIG. 8 is a schematic diagram of another embodiment of an operational mode, in accordance with the present disclosure;

FIG. 9 is a schematic diagram of another embodiment of a timing diagram, in accordance with the present disclosure;

FIG. 10 is a schematic diagram of another embodiment of an operational mode, in accordance with the present disclosure;

FIG. 11 is a schematic diagram of another embodiment of an operational mode, in accordance with the present disclosure;

FIG. 12 is a schematic diagram of another embodiment of a timing diagram, in accordance with the present disclosure;

FIG. 13 is a schematic diagram of another embodiment of an operational mode, in accordance with the present disclosure;

FIG. 14 is a schematic diagram of another embodiment of a timing diagram, in accordance with the present disclosure;

FIG. 15 is a schematic diagram of another embodiment of an operational mode, in accordance with the present disclosure;

FIG. 16 is a schematic diagram of another embodiment of an operational mode, in accordance with the present disclosure;

FIG. 17 is a schematic diagram of another embodiment of a timing diagram, in accordance with the present disclosure;

FIG. 18 is a schematic diagram of another embodiment of an operational mode, in accordance with the present disclosure;

FIG. 19 is a schematic diagram of another embodiment of a timing diagram, in accordance with the present disclosure;

FIG. 20 is a schematic diagram of another embodiment of an operational mode, in accordance with the present disclosure;

FIG. 21 is a schematic diagram of another embodiment of an operational mode, in accordance with the present disclosure;

FIG. 22 is a schematic diagram of another embodiment of a timing diagram, in accordance with the present disclosure;

FIG. 23 is a schematic diagram of another embodiment of an operational mode, in accordance with the present disclosure;

FIG. 24 is a schematic diagram of another embodiment of a timing diagram, in accordance with the present disclosure;

FIG. 25 is a schematic diagram of another embodiment of an operational mode, in accordance with the present disclosure;

FIG. 26 is a schematic diagram of another embodiment of an operational mode, in accordance with the present disclosure;

FIG. 27 is a schematic diagram of another embodiment of a timing diagram, in accordance with the present disclosure;

FIG. 28 is a schematic diagram of another embodiment of an operational mode, in accordance with the present disclosure;

FIG. 29 is a schematic diagram of another embodiment of an operational mode, in accordance with the present disclosure;

FIG. 30 is a schematic diagram of another embodiment of a timing diagram, in accordance with the present disclosure;

FIG. 31 is one embodiment of a table of command sequences and resulting implied modes of operation, in accordance with the present disclosure; and

FIG. 32 is another summary table of modes and mode descriptions, in accordance with the present disclosure.

### DETAILED DESCRIPTION

According to the present disclosure, one embodiment may take the form of a method for receiving information from an emitter. In this embodiment, a command sequence may include shutter timing information and may include at least one command from a set of four commands. The commands within the command sequence may indicate difference functions and may depend on at least the relative timing location to one another, the quantity of each command in the command sequence and the order of the commands relative to one another. Additionally, at least one command of the set of four commands may be received after the function should occur. A receiver may receive a signal which may include at least the command sequence. Further, once the receiver has received the same command sequence a couple of times, an operating mode may be determined which may allow additional commands to be implied, even though the additional commands may not actually be received by the receiver.

According to another aspect of the present disclosure, a method for conveying information to a receiver may include providing a command sequence, in which the command sequence may include shutter timing information and the command sequence may include at least one command of a set of commands, and further, the commands may indicate different functions depending on a timing location. The method may further include enabling an emitter to emit a signal containing at least the command sequence. The commands may indicate different functions depending on the order of the commands relative to one another and on the quantity of each command included in the command sequence. The command sequence may define an operating mode for shutter eyewear, in which the operating mode may be assumed to be stable after at least two command sequences. The method may include defining the time between lens actions and commands as a fraction of a lens sequence period and defining the time between lens actions and commands may include measuring the lens sequence period between the centers of commands for all but non-symmetric modes. Additionally, the method may remove dependency on real time counting in the shutter timing information and may provide the signal as an infrared signal. Moreover, the method may include substantially removing timing holes in the duty cycle and period options due to command timing restrictions.

According to yet another aspect of the present disclosure, a method for receiving information from an emitter, may include receiving a command sequence that may include shutter timing information, in which the command sequence may include at least one command of a set of commands, and further, the commands may indicate different functions depending on a timing location and at least one command of the set of commands may be received after the function should occur. The method may also include enabling a receiver to receive a signal including at least the command sequence. The commands may indicate different functions depending on the order of the commands relative to one another within the command sequence and on the quantity of each command included in the command sequence. The command sequence may be received by shutter eyewear and the command sequences may define an operating mode for the shutter eyewear. The method may further include defining the time between lens actions and commands as a fraction of a lens sequence period, and in which defining the time between lens actions and commands may include measuring the lens sequence period between the centers of commands for all but non-symmetric modes. Further, the method may include removing dependency on real time counting in the shutter timing information, in which the lens sequence period may not be a fixed time, and also may include determining an operating mode after receiving more than two cycles of command sequences. Moreover, the method may include continuing the operating mode after determining the operating mode by assuming the operating mode may remain substantially stable.

According to yet another aspect of the present disclosure, a shutter timing protocol for conveying information may include a set of commands in which at least one of the commands may be received after the function should be performed, and may also include a command sequence which may include at least one of the commands of the set of commands, in which the commands may indicate different functions to be performed depending on the quantity of each command within the command sequence and depending on the timing location of the command within the command sequence. The command sequence may substantially remove timing holes in the duty cycle and period options due to command timing restrictions

It should be noted that embodiments of the present disclosure may be used in a variety of display systems, optical systems and projection systems. The embodiment may include or work with a variety of displays, display systems, entertainment systems, projectors, projection systems, optical components, computer systems, processors, self-contained projector systems, visual and/or audiovisual systems and electrical and/or optical devices. Aspects of the present disclosure may be used with practically any apparatus related to display, optical and electrical devices, optical systems, entertainment systems, presentation systems or any apparatus related to systems that emit or receive signals. Accordingly, embodiments of the present disclosure may be employed in display systems, devices used in visual and/or optical presentations, visual peripherals and so on and in a number of computing environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

U.S. patent application Ser. No. 12/796,494, entitled “Shutter-glass eyewear control,” filed Jun. 8, 2010 is herein incorporated by reference in its entirety.

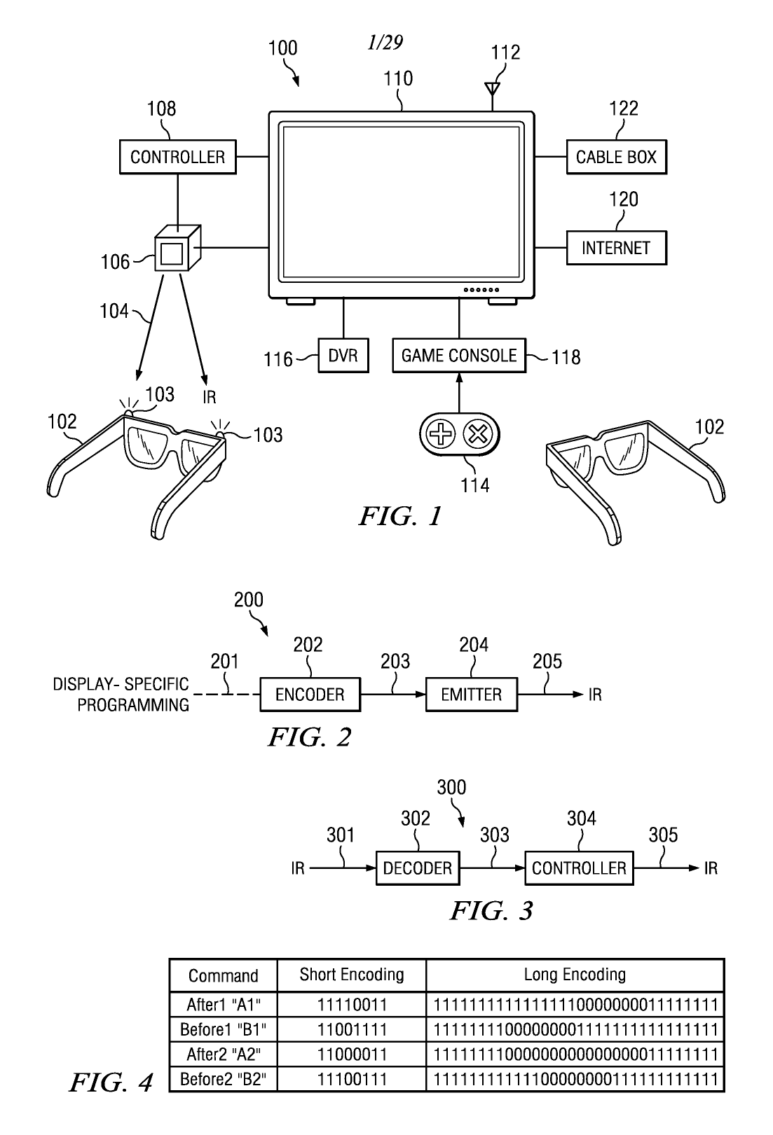

FIG. 1 is a schematic diagram of a shutter glass eyewear system 100. The shutter glass system 100 may include a display 110 viewed by one or more viewers wearing shutter glasses 102. The shutter glasses 102 may have a receiver 103 for receiving signals 104 from an emitter 106. In one example, the receiver 103 may be an infrared receiver and the signals 104 may be infrared signals. Continuing the example, the emitter 106 may be an infrared emitter 106 and may be connected to a controller 108 and the controller 108 may be connected to the display 110. Additionally, any of the components of FIG. 1 may be operationally, directly, indirectly, functionally or otherwise connected to one another.

In another example, a 3D-ready television may have a jack for connecting to the emitter 106 of FIG. 1. In addition, the emitter 106 and controller 108 may be contained in the same casing (not shown). The display 100 may contain the controller 108 and the emitter 106 in the display 110 casing (also not shown). The display 100 may be any type of display type, including but not limited to, liquid crystal displays (LCDs), plasma display panels (PDPs), digital light processing systems (DLP systems), front projectors, screens which may be illuminated from front and/or behind, light emitting diode systems (LED systems) including continuous and LED back-lit displays, and so forth. The display 110 may be connected to other video devices or streaming content devices including, but not limited to, a game console 118, cable, satellite, or set top box 122, internet-connected device 120, antenna 112, and DVR player 116. Internet-connected device 120 may provide streaming video media, downloaded media, websites, internet applications, and the like. In one example, a viewer wearing shutter glasses 102 may operate a game controller 114 associated with the gaming console 118.

FIG. 2 is a schematic diagram of one embodiment of a shutter glass eyewear system. The configuration of apparatus 200 in FIG. 2 includes an encoder 202 and an emitter 204, for a shutter glass eyewear system. The encoder 202 and emitter 204 may be associated with a display in a shutter glass eyewear system (as shown in FIG. 1). The encoder 202 may consider display specific programming when encoding a control sequence 203. The encoder 202 may encode a control sequence 203, which may provide instructions for the shutter glass eyewear and the emitter 204 may emit an infrared signal 205 of the control sequence 203. For discussion purposes only and not of limitation, the wireless signal may be referred to herein as the IR signal

Continuing the discussion of FIG. 2, although the encoder 202 and the emitter 204 may be illustrated as separate elements, one of ordinary skill in the art would understand that the encoder 202 and the emitter 204 may be included in a single device. For example, the encoder 202 and the emitter 204 may be part of a display, a game console, a cable, satellite, or set top box, an internet-connected device, antenna, and DVR player, a DVD player, and so on. Also, elements of the encoder 202 and emitter 204 may comprise hardware, software, or a combination of both. In some embodiments, the encoder 202 and the emitter 204 may be part of, or encased within a display, while in other embodiments, the encoder 202 and the emitter 204 may be separate devices for use with a display.

FIG. 3 is a schematic diagram of another embodiment of a shutter glass eyewear system. The configuration of apparatus 300 in FIG. 3 includes a decoder 302 and a controller 304, for a shutter glass eyewear system. The decoder 302 and controller 304 may be associated with the infrared receiver of the shutter glasses in an eyewear system (as shown in FIG. 1). In operation, the decoder 302 may decode an infrared signal of a control sequence and may provide the decoded signal 303 to a controller mechanism 304. The controller mechanism 304 provides a command signal 305, which may provide instructions to the shutter glass eyewear. The command signal 305 will be discussed in further detail below. FIG. 3 illustrates the decoder 302 and controller 304 as separate elements, but one of ordinary skill in the art would understand that the decoder 302 and controller 304 may be included in a single device. Additionally, elements of the decoder 302 and controller 304 may comprise hardware, software, or a combination of both.

Wireless or wired signaling may be used to transmit information from a display device to shutter eyewear. The wireless signal may be an IR signal, RF signal, wireless Internet Protocol (“IP”) connection, WiMax, bluetooth, Zigbee, IEEE 802.11, any short range signal, or combinations thereof or otherwise. For discussion purposes only and not of limitation, the wireless signal may be referred to herein as the IR signal. The transmitted information may include synchronization and shutter timing information to control the shuttering action of the shutter eyewear. Further, the transmitted information may include commands and/or command sequences which will be discussed in further detail below. Generally, emitters may emit IR signals in the approximate range of 830 nm to 950 nm and accordingly, receivers may receive in the approximate range of 830 nm to 950 nm. With that said, the IR signal may be centered at approximately 950 nm or in some cases approximately 830 nm which may reduce interference with IR remote control devices.

A pulse code protocol may be utilized to indicate the function that the eyewear should execute. The pulse code protocol may include commands individually, repeated or in combination, which may indicate different functions to be performed based on the command sequences. Further, the commands that may be communicated to the receiver may be received before the function should be executed or after the function should have been executed. These cases will be discussed in further detail below. The protocol may include a minimum 2 pulse/no pulse pseudo carrier scheme. Additionally, the command sequences may start and end with pulses. Generally, commands may include an indication to perform a specific function. For example, commands may provide direction to open a left shutter, open a right shutter, close the left shutter, close the right shutter, open both left and right shutters, close both the left and right shutters, open or close the left shutter for a specific amount of time, open or close the right shutter for a specific amount of time, open or close both shutters for a specific amount of time, any combination thereof and so on. In one example, the approximate lens transition from an open state to a closed state may occur when the transmittance is at or below approximately 1% and the lens transition from a closed state to an open state may occur when the transmittance is at or above approximately 1%.

The commands may be encoded as bit values and as previously discussed may be used to communicate an instruction that may or may not modify the current state of the eyewear shutters. In one example and as indicated in FIG. 4, a protocol may include four commands.

FIG. 4 is a schematic diagram of one embodiment of a table of command encodings. In FIG. 4, table 400 lists a set of four commands. In column 410, the following commands are listed: After1 (A1), Before1 (B1), After2 (A2), and Before2 (B2). In one example, the four commands of FIG. 4 may be utilized to control the shuttering of eyewear. The command sequence may include an order and/or repetition of commands per viewing or image cycle and may define the mode of operation. The mode of operation will be discussed in further detail below.

As shown in FIG. 4, two lengths of command encoding may be utilized, a short encoding, illustrated in short encoding column 420 and a long encoding column 430. Additionally, interference rejection may be assisted by using two lengths of command encoding. Short encoding may be used to reduce emitted energy, thus reducing power consumption of the system and long encoding may be used for better immunity to a “noisy” environment. Further, power may be reduced in the emitter and receiver. The command encoding frequency or 1/Tcycle, may be approximately 26.2 KHz, as measured at approximately the 50% emitted IR intensity levels. Moreover, the lens action versus command timing may have relative command spacing, such as 1/16th of a period rather than a fixed time and this may remove the need for real time counting. The command timing may be the time between lens action and commands and the 1/16^{th} of the lens sequence period may be measured from command center for all modes. In general, the timing may be achieved with shift and add operations, as per the tables at the bottom of each mode description. This may be useful for low performance micro controllers and dedicated state machines which may perform such functions.

The carrier frequency may vary approximately +/−5% of the command encoding frequency as measured at approximately the 50% emitted IR intensity levels. Further, the duty cycle of the carrier frequency or (Thigh/Tcycle) % may in the approximate range between 45% to 55% and the approximate time for the emitted IR intensity to go from 10% to 90% (Tr) may not be greater than approximately 5% of Tcycle and likewise, the approximate time for the emitted IR intensity to go from 90% to 10% (TO may not be greater than approximately 5% of Tcycle, all when measured at approximately 50% of the emitted IR intensity levels.

Each of the four commands may be transmitted to the receiver using ON-OFF keying (OOK) of the carrier. Also, each of the four commands may consist of two ON periods separated by a single OFF period and each of the four commands may be of equal length. The proportional relationship between the ON and OFF periods may be used to decode the commands. It may not be appropriate to determine the actual number of carrier cycles in each period.

The mode of operation specified by the command sequence may communicate information including modes of operation such as, but not limited to, dual view, 2D, 3D, symmetrical, asymmetrical, single, swap, quad, any combination thereof, and so on. The number of images per image cycle may be specific to the mode of operation. In one example of 3D, the image pairs may come together as left (odd image number) and then right (even image number) in the image cycle. For the Half and Swap operational modes we may assume the number of images, and that the period, duty and phase will be the same for all images. So the period and phase may be communicated in these modes, which may allow use of one command.

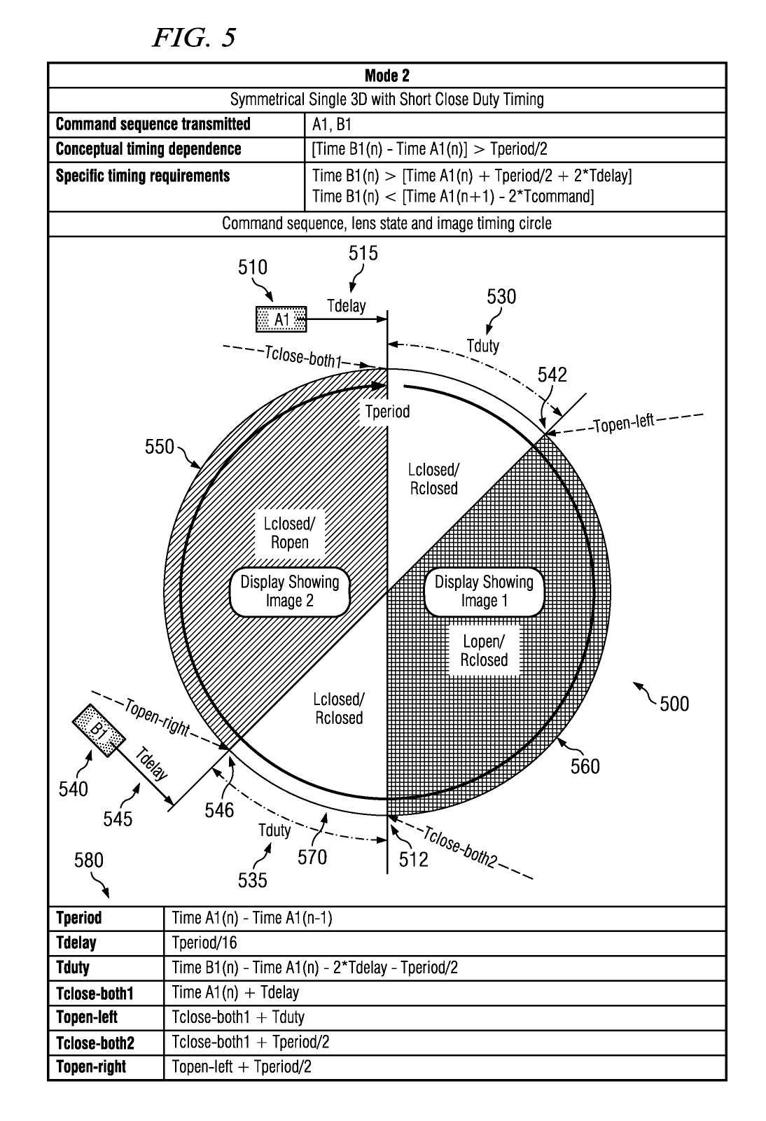

FIG. 5 is a schematic diagram of one embodiment of an image timing circle 500. FIG. 5 illustrates a timing circle 500 for which may also be referred to herein as the symmetrical single 3D with short close duty timing mode. Mode 2 may be specified by the command sequence A1, B1 and the timing locations as shown in FIG. 5. As shown in FIG. 5, command A1 510 is illustrated at approximately the 12:00 position of the timing circle 500. After command A1 510 may be received by shutter eyewear (not shown in FIG. 5) and a time of Tdelay 515 may elapse, both the left and right shutters may close as illustrated by section 520 for a period of time, Tduty 530. Next, command B1 540 may be received by shutter eyewear and is illustrated at approximately the 7:30 position of the timing circle 500. The left shutter may close and the right shutter may open and an Image 2 may be viewed through the right shutter for a period of time illustrated by section 550. Furthermore, because command B1 540 occurs between the 6:00-12:00 positions of the timing circle 500, the operating mode may be 3D.

Although periods of time 560 and 570 may have elapsed prior to command B1 540, because the command B1 540 was not received until the 7:30 position illustrated in timing circle 500, the left and right shutters may remain closed through the sections 560 and 570 for at least the first cycle of the timing circle 500. After the shutter eyewear receives the commands A1 510 and B1 540 for a couple of cycles, in which the commands are substantially stable and spaced in time as illustrated by the timing circle 500, the shutter eyewear may determine a mode of operation. Once the operating mode is determined, then a symmetric implied B1 point 542, also labeled Topen-left, may be implied across the timing circle. Stated differently, at B1 point 542, no additional command may be received, however the left shutter may open and the right shutter may close for the section 560. Further, a symmetric implied A1 point 512, also labeled Tclose-both2, may be implied across the timing circle at the 6:00 position. At A1 point 512, again although no additional command may be received, the left and right shutter may close for the section 570 for a time period of Tduty 535.

Continuing the discussion of FIG. 5, command B1 540 may be received after the implied B1 point 546, also labeled Topen-right, where the shuttering action may take place. Although the implied B1 point 546 may be the point at which the shuttering action occurs, the command B1 540 may not be received until a Tdelay 545 time period elapses following the B1 point 546. Stated differently, although the command B1 540 may not have been received, the operating mode may allow the shuttering action to be implied before the command may actually be received.

The table 580 is also shown in FIG. 5. The table 580 includes approximate time periods for functions that occur in the symmetrical single 3D with short close duty timing mode and demonstrates that the time periods for functions may depend on the relative timing locations. As shown in FIG. 5, Tperiod may be approximately the Time A1(n)−Time A1(n−1). Stated differently, Tperiod may be approximately the time between receiving a first command A1 and a second command A1. Also in table 580, Tdelay may be approximately Tperiod/16. Furthermore, both the right and left shutter may close at a 12:00 position, or as labeled on the timing circle 500 the Tclose-both1 position. This first position in time may be defined approximately by the time at which the A1 command 510 is received plus the Tdelay 515. The second position labeled as Topen-left on the timing circle 500 may be the time at which the left shutter may open. The second position may be defined approximately by the time at which Tclose-both1 position occurs at approximately 12:00 plus Tduty 530. Although the Tduty time periods may be specified relative to the command that precedes or follows Tduty, the time periods are substantially the same for both Tduty time periods discussed with respect to Mode 2. Similarly, the Tduty time periods may be substantially the same period of time within and with respect to Mode 3 (but Tduty of Mode 2 and Tduty of Mode 3 may be different, and so on). The third position on the timing circle 500 labeled as Tclose-both2 at the 6:00 position, may be defined approximately by the time at which the Tclose-both1 position occurs plus Tperiod/2. The fourth position on the timing circle 500 labeled as Topen-right may be the approximate time at which the right shutter may open. The fourth position may be defined approximately by the time at which the second command Topen-left occurs plus Tperiod/2. Tduty may be set forth as, Time B1(n)−Time A1(n)−2*Tdelay−Tperiod/2.

Still continuing with FIG. 5, the conceptual timing dependence for the symmetrical single 3D with short close duty timing mode is set forth. The conceptual timing dependence for this mode may be set forth such that [Time B1(n)−Time A1(n)]>Tperiod/2. As previously mentioned, the B1 command 540 may be received between the 6:00-12:00 positions of the timing circle 500 and the conceptual timing dependence illustrates the dependence of the mode on the type of command received as well as the time at which it was received. Additionally, the “specific timing requirements” for Mode 2 are included in FIG. 5 and may be set forth as Time B1(n)>[Time A1(n)+Tperiod/2+2*Tdelay] and Time B1(n)<[Time A1(n+1)−2*Tcommand]. Tcommand may be referred to as the command timing and may be the transit time for each command, which may be approximately equal relative to whether short or long encoding may be selected. Further the actual transit time may be approximately 305 microseconds for short command encoding and approximately 1220 microseconds for long command encoding.

In the example of FIG. 5, since Mode 2 is a symmetrical mode, the commands A1 and B1 may imply functions to take place at an approximate time Tperiod/2 across the timing circle from the point at which the commands A1 and B1 were actually received. Additionally, because B1 arrives between the 6:00 and 12:00 positions on the timing circle, the operating mode may be in 3D. Moreover, the short close duty timing may be indicated by looking to the locations of the Tdelay time periods. As command B1 moves closer in time clockwise to command A1, keeping in mind B1 may stay between 6:00-12:00 on the timing circle, commands A1 and B1 may be minimally separated in time by at least 2*Tcommand. However, as command B1 moves closer in time to the 6:00 position on the timing circle, Tduty 535 may become smaller and may not be limited by the Tdelay times associated with the commands in the command sequence. In one example of Mode 2, Tduty 535 may be smaller than the duration of a single Tdelay time. Since all except the single command modes may have two timing methods, long and short closed duty, there may no longer be any “holes” in the duty due to the Tdelay times that accompany the commands and period options due to command timing restrictions. Tduty may be set forth for Mode 2 as Time B1(n)−Time A1(n)−2*Tdelay−Tperiod/2.

For symmetrical operational modes, we may assume that most, if not all, the images may have substantially the same period, duty, and phase alignment. This allows us to determine the approximate timing for the images with just one period, duty, and phase being communicated with the commands. Separate operational modes may be used for asymmetrical image periods and duties which will be discussed in further detail below.

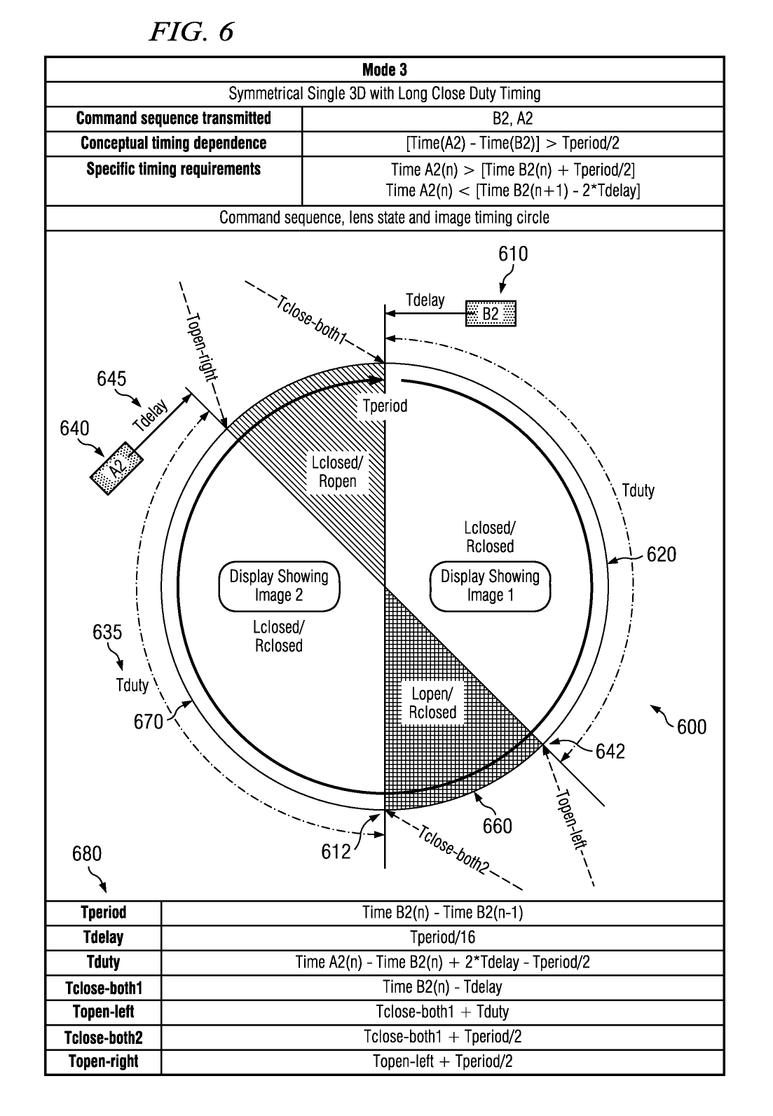

Another mode of operation, Mode 3, may be specified by the command sequence B2, A2 and the timing locations as shown in FIG. 6. FIG. 6 is another embodiment of an image timing circle 600. Mode 3 may also be referred to herein as symmetrical single 3D with long close duty timing. As shown in Mode 3, command B2 610 may be received, but similar to Mode 2, for the first couple of cycles, the left and right shutters may not close at the position labeled as Tclose-both1. Instead, for the first couple of cycles, the left and right shutter may close for a period of time, which may be less than section 620, beginning after the command B2 610 is received instead of at position Tclose-both1 located at the 12:00 position.

Next, command A2 640 may be received by shutter eyewear (not shown in FIG. 6) and a time of Tdelay 645 may elapse, then the right shutter may open and the left shutter may close at a position Topen-right located on the timing circle. Additionally, and similar to Mode 2, although periods of time 660 and 670 may elapse between the two received commands, the shutters may not change position because an operating mode has not yet been determined for the first couple of cycles. After the shutter eyewear receives the commands B2 610 and A2 640 for a couple of cycles and the commands and spacing in time are substantially stable, the shutter eyewear may determine an operating mode. Once the operating is determined, symmetric commands B2 and A2 may be implied at a time Tperiod/2 from the received commands B2 610 and A2 640.

As shown in FIG. 6, the second position 642 labeled Topen-left may be implied by the A2 command 640 and the third position 612 labeled Tclose-both2 may be implied by the B2 command 610. Similarly, and as described with respect to Mode 2, in Mode 3 no commands may actually be received at the second position 642 and third position 612, but the operating mode, Mode 3, may imply the commands and thus, the shutters may switch accordingly.

Distinct from Mode 2, Mode 3 of FIG. 6 is a long close duty timing mode. To clarify, it is possible as the command A2 640 approaches the 12:00 position of the timing circle, Tduty 635 may be less than a time of Tdelay and may be minimized. However, as the command A2 640 approaches the 6:00 position of the timing circle, Tduty 635 may be, at a minimum greater than 2*Tdelay. Tduty may be set forth for Mode 3 as Time A2(n)−Time B2(n)−2*Tdelay−Tperiod/2.

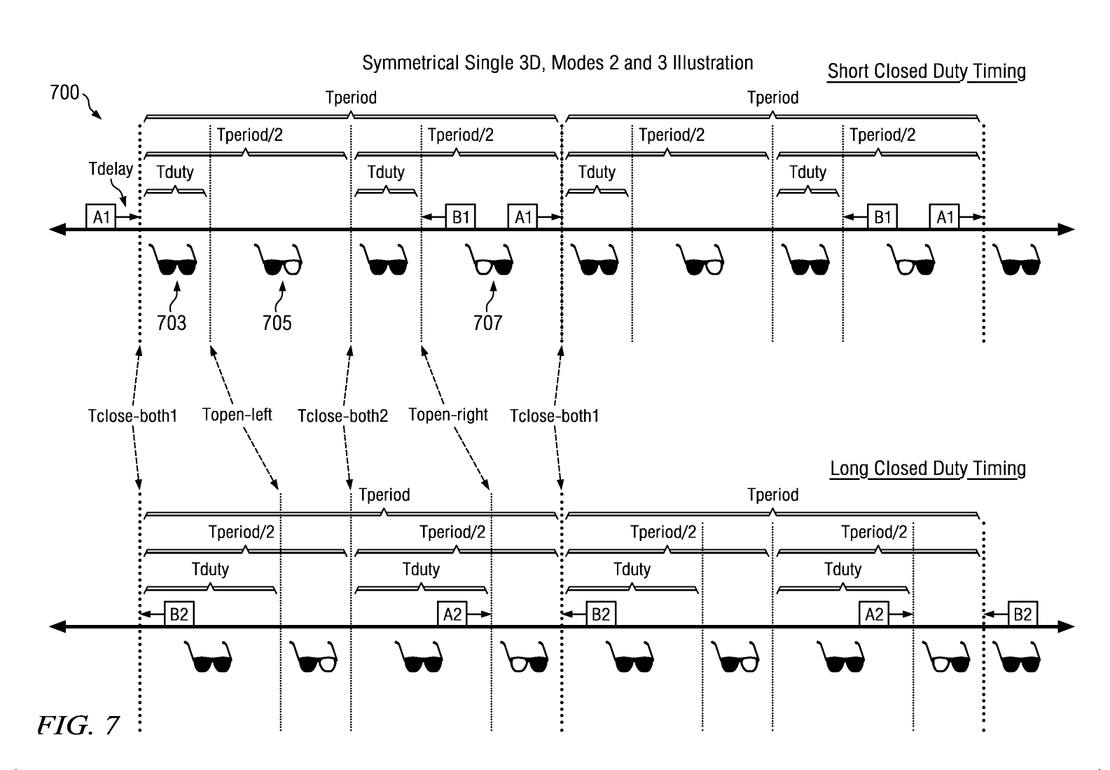

FIG. 7 is a schematic diagram of one embodiment of a timing diagram. Similar to FIGS. 5 and 6, FIG. 7 illustrates two modes, Mode 2 and Mode 3, in the form of a timing diagram. The timing diagram 700 of Mode 2 illustrates the shutter timing and includes many of the same descriptive elements as the timing circle 500 of FIG. 5. For example, FIG. 7 includes the approximate time periods for functions that occur in the symmetrical single 3D with short close duty timing mode. More specifically, FIG. 7 includes Tduty, Tperiod, Tclose-both1, Topen-left, Tclose-both2, Topen-right, Tdelay, and so on. Furthermore, FIG. 7 includes shutter eyewear 703, 705, and 707 which depict both left and right shutters closed, the right shutter closed and the left shutter open, and the right shutter open and the left shutter closed, respectively. Shutter eyewear 703 appears in FIG. 7 in a time period analogous to section 520 of FIG. 5. Likewise, shutter eyewear 705 in FIG. 7 appears in a time period analogous to section 560 of FIG. 5, and shutter eyewear 707 of FIG. 7 appears in an analogous time period of section 550 of FIG. 5, and so on.

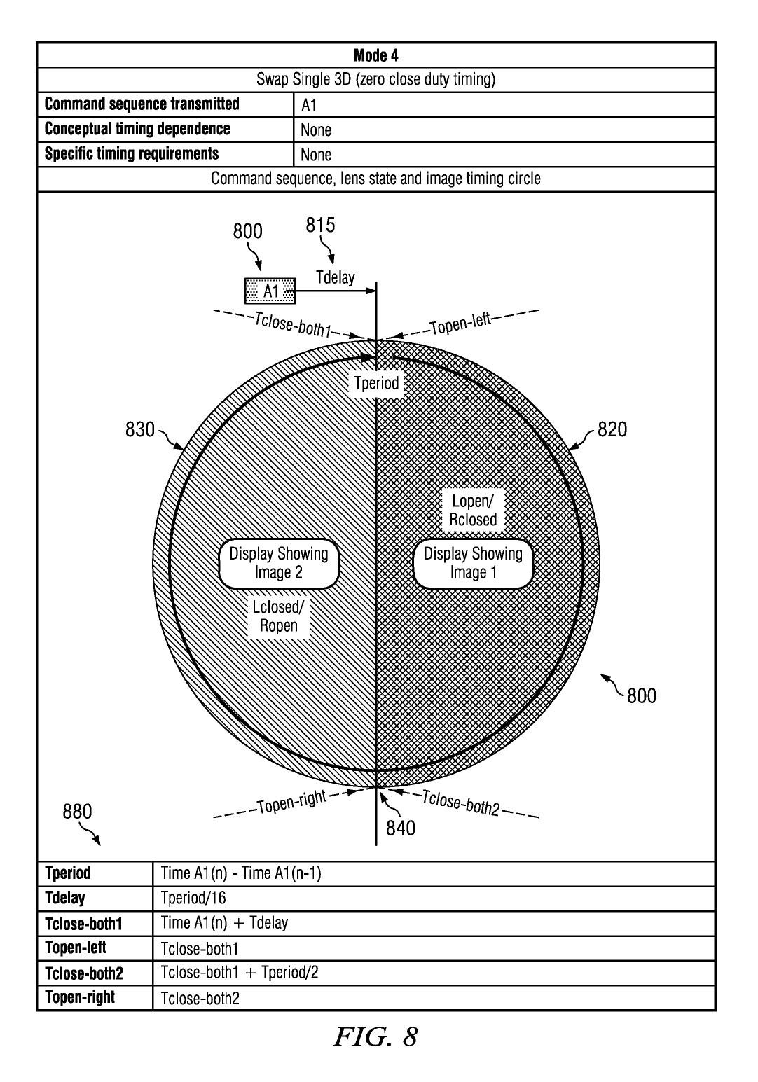

FIG. 8 is a schematic diagram of another embodiment of a timing circle. FIG. 8 illustrates a timing circle 800 for Mode 4 which may also be referred to herein as the swap single 3D (zero close duty timing) mode. The command sequence that may be transmitted for Mode 4 is command A1 810. As shown in FIG. 8, there is substantially no period of time in which both the left and the right shutters may be closed. Accordingly, the command A1 810 may be received and after a Tdelay 815, at the first position labeled Topen-left, which is located at approximately the 12:00 position, the left shutter may open and the right shutter may close. Similar to the previous modes described, during the first couple of cycles, the shutters may remain in the same positions for section 820 and may not change positions as depicted in section 830. After the same command sequence has been received approximately two or more times, an operating mode (Mode 4) may be determined. Once the operating mode has been determined, at the second position labeled Tclose-right 840, an implied A1 command may be applied at approximately Tperiod/2 across the timing diagram. At the second position, the right shutter may open and the left shutter may close.

The table 880 is also shown in FIG. 8. The table 880 includes approximate time periods for functions that occur in the swap single 3D (zero close duty timing) mode and demonstrates that the time periods for functions may depend on the relative timing locations relative. As shown in FIG. 8, Tperiod may be approximately the Time A1(n)−Time A1(n-1). Stated differently, Tperiod may be approximately the time between receiving a first command A1 and a second command A1. Also in table 880, Tdelay may be approximately Tperiod/16. Furthermore, both the right and left shutter may close at a 12:00 position, or as labeled on the timing circle 800 as the Tclose-both1 position. This first position in time may be defined approximately by the time at which the A1 command 810 is received plus the Tdelay 815 or as notated in table 880 Time A1(n)+Tdelay. Further, the left shutter may open at time labeled Topen-left on the timing circle 800, also located at approximately the 12:00 position, may be set forth as Tclose-both1. The second position labeled as the Tclose-both2 position on the timing circle 800 may be the time at which the both the left and right shutter may close. The second position may be set forth as approximately by the time at which Tclose-both1 position occurs plus Tperiod/2. The right shutter may open at time labeled Topen-right on the timing circle 800, also approximately located at 6:00, and may be set forth as Tclose-both2.

Still continuing with FIG. 8, the conceptual timing dependence and the “specific timing requirements” for the swap single 3D (zero close duty timing) mode, Mode 4, may not be set forth.

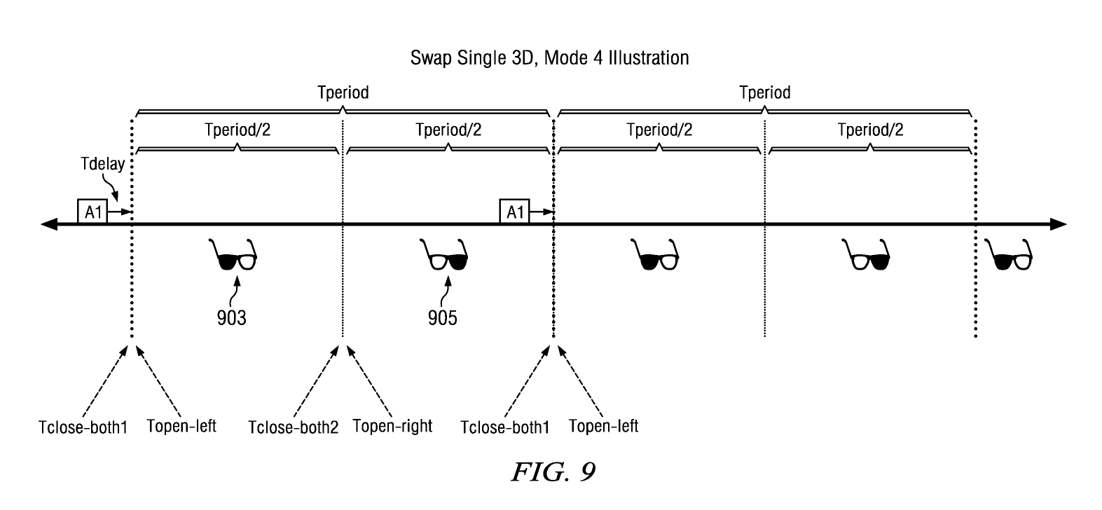

FIG. 9 is a schematic diagram of another embodiment of a timing diagram. Similar to FIG. 8, FIG. 9 illustrates Mode 4 in the form of a timing diagram. The timing diagram 900 of Mode 4 illustrates the shutter timing and includes many of the same descriptive elements as the timing circle 800 of FIG. 8. For example, FIG. 9 also includes the approximate time periods for functions that occur in the swap single 3D mode. More specifically, FIG. 9 includes Tperiod, Tclose-both1, Topen-left, Tclose-both2, Topen-right, Tdelay, and so on. Furthermore, FIG. 9 includes at least shutter eyewear 903 and 905 which depict the right shutter closed and the left shutter open, and the right shutter open and the left shutter closed, respectively. Shutter eyewear 903 appears in FIG. 9 in a time period analogous to section 820 of FIG. 8. Likewise, shutter eyewear 905 appears in a time period in FIG. 9 analogous to section 830 of FIG. 8, and so on.

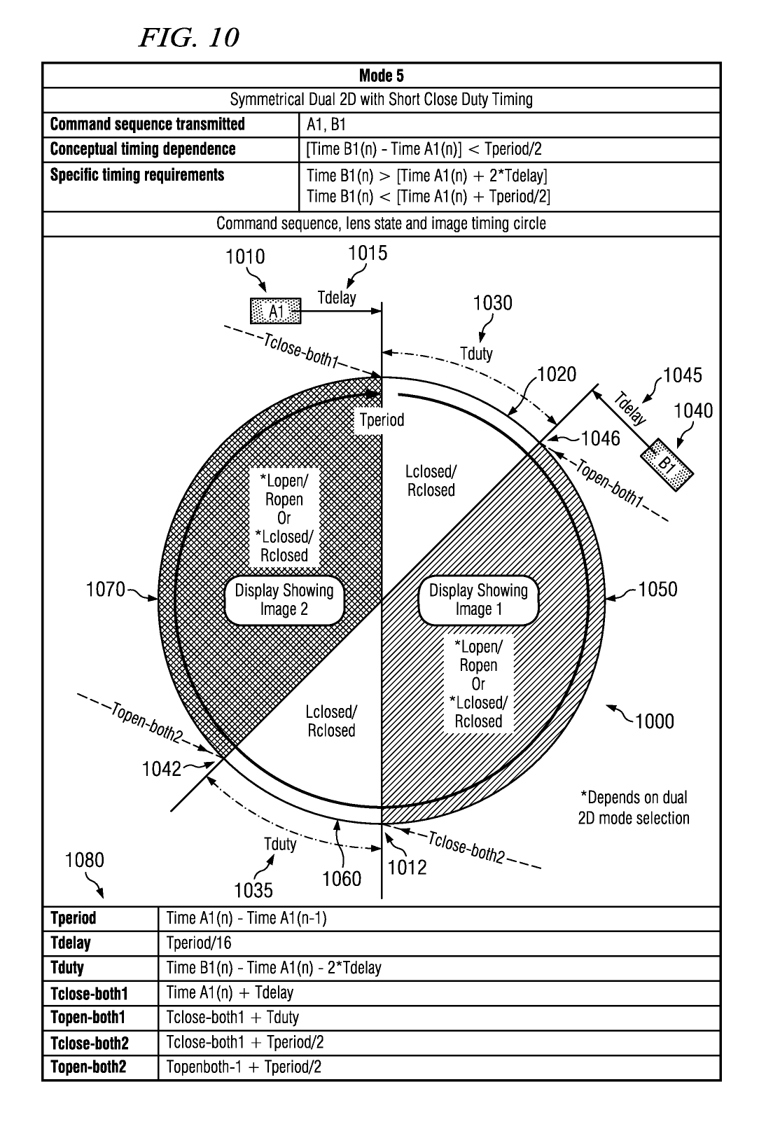

FIG. 10 is a schematic diagram of another embodiment of an image timing circle 1000. FIG. 10 illustrates one embodiment of Mode 5 which may also be referred to herein as symmetrical dual 2D with short close duty timing mode. As shown in FIG. 10, command A1 1010 is illustrated at approximately the 12:00 position of the timing circle 1000. After command A1 1010 may be received by shutter eyewear (not shown in FIG. 10) and a time of Tdelay 1015 may elapse, both the left and right shutters may close at the position Tclose-both1, illustrated by section 1020 for a period of time, Tduty 1030. Next, command B1 1040 may be received by shutter eyewear and is illustrated at approximately the 2:30 position of the timing circle 1000. Both the left and right shutters may open or close depending on which dual 2D mode may be selected. The left and right shutter may be open or closed for a period time illustrated by section 1050. Furthermore, because command B1 1040 occurs between the 12:00-6:00 positions of the timing circle 1000, the operating mode may be dual 2D.

Although periods of time 1060 and 1070 may have elapsed, because an operating mode may not have been determined yet, the left and right shutters may not have changed shuttering states through the sections 1060 and 1070 for at least the first cycle of the timing circle 1000. After the shutter eyewear receives the commands A1 1010 and B1 1040 for a couple of cycles, in which the commands are substantially stable and spaced in time as illustrated by the timing circle 1000, the shutter eyewear may determine a mode of operation. Once the operating mode is determined, then a symmetric implied B1 point 1042, also labeled Topen-both2, may be implied across the timing circle. Stated differently, at implied B1 point 1042, no additional command may be received, however both the left and right shutter may switch to open or closed, again depending on which dual 2D mode may be selected. The left and right shutters may be open or closed for the period of time defined approximately by the section 1070. Further, a symmetric implied A1 point 1012, also labeled Tclose-both2, may be implied across the timing circle from command A1 1010, at approximately the 6:00 position. At implied A1 point 1012, again although no additional command may be received, the left and right shutter may close for the section 1060 for a time period of Tduty 1035.

Continuing the discussion of FIG. 10, command B1 1040 may be received after the point 1046, also labeled Topen-both1, where the shuttering action may take place. Although the point 1046 may be the point at which the shuttering action occurs, the command B1 1040 may not be received until a Tdelay 1045 time period elapses following the point 1046. Stated differently, although the command B1 1040 may not have been received, the operating mode may allow the shuttering action to be implied before the command may actually be received.

The table 1080 is also shown in FIG. 10. The table 1080 includes approximate time periods for functions that occur in the symmetrical dual 2D with short close duty timing mode and demonstrates that the time periods for functions may depend on the relative timing locations relative. As shown in FIG. 10, Tperiod may be approximately the Time A1(n)−Time A1(n-1). Stated differently, Tperiod may be approximately the time between receiving a first command A1 and a second command A1. Also in table 1080, Tdelay may be approximately Tperiod/16. Furthermore, both the right and left shutter may close at a 12:00 position, or as labeled on the timing circle 1000 the Tclose-both1 position. This first position in time may be defined approximately by the time at which the A1 command 1010 is received plus the Tdelay 1015. The second position labeled as Topen-both1 on the timing circle 1000 may be the time at which the both the left shutter and the right shutter may open or close depending on the dual 2D mode selection. The second position may be defined approximately by the time at which Tclose-both1 position occurs plus Tduty 1030. The third position on the timing circle 1000 labeled as Tclose-both2 at the 6:00 position, may be defined approximately by the time at which the Tclose-both1 position occurs plus Tperiod/2. The fourth position on the timing circle 1000 labeled as Topen-both2 may be the approximate time at which both the left and the right shutter may open or close depending on the dual 2D mode selection. The fourth position may be defined approximately by the time at which the second command Topen-both1 occurs plus Tperiod/2. Tduty may be set forth for Mode 5 as Time B1(n)−Time A1(n)−2*Tdelay.

Still continuing with FIG. 10, the conceptual timing dependence for the symmetrical dual 2D with short close duty timing mode is approximately set forth. The conceptual timing dependence for this mode may be set forth such that [Time B1(n)−Time A1(n)]<Tperiod/2. As previously mentioned, the B1 command may be received between the 12:00-6:00 positions of the timing circle 1000 and the conceptual timing dependence illustrates the dependence of the mode on the type of command received as well as the time at which it was received. Additionally, the “specific timing requirements” for Mode 5 are included in FIG. 10 and may be set forth as Time B1(n)>[Time A1(n)+2*Tdelay] and Time B1(n)<[Time A1(n)+Tperiod/2]. As previously mentioned, regarding command timing, the actual transit time may be approximately 305 microseconds for short command encoding and approximately 1220 microseconds for long command encoding.

In the example of FIG. 10, since Mode 5 is a symmetrical mode, the commands A1 and B1 may imply functions to take place at a time Tperiod/2 across the timing circle from the point at which the commands A1 and B1 were actually received. Additionally, because B1 arrives between the 12:00 and 6:00 positions on the timing circle, the operating mode may be in 2D. Moreover, the short close duty timing may be indicated by looking to the locations of the Tdelay time periods. As command B1 moves closer in time counterclockwise to command A1, keeping in mind B1 may stay between 12:00-6:00 on the timing circle, commands A1 and B1 may be minimally, Tduty may be smaller than the duration of a single Tdelay time. Since all except the single command modes may have two timing methods, long and short closed duty, there may no longer be any “holes” in the duty due to the Tdelay times that accompany the commands and period options due to command timing restrictions

Further, as command B1 moves closer in time to the 6:00 position on the timing circle, Tduty may become larger and may be limited by the Tdelay times associated with the commands in the command sequence.

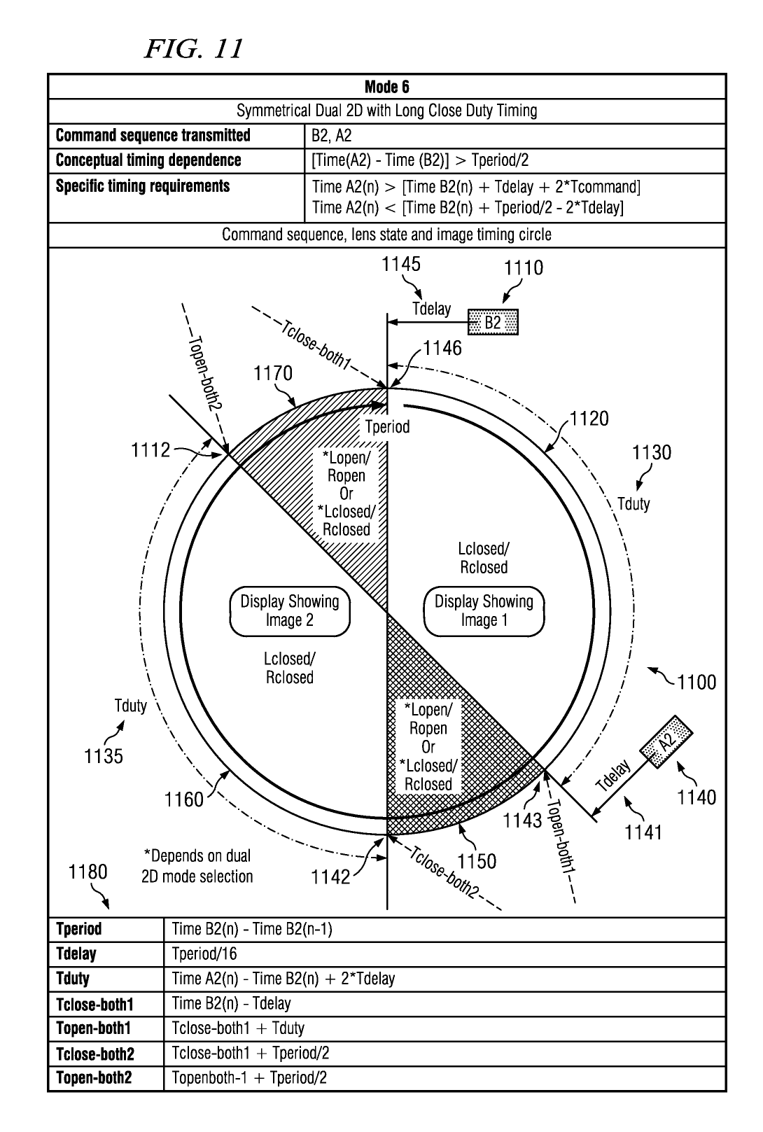

Another mode of operation, Mode 6, may be specified by the command sequence B2, A2 and the timing locations as shown in FIG. 11. FIG. 11 is a schematic diagram of another embodiment of an image timing circle 1100. Mode 6 may also be referred to herein as symmetrical dual 2D with long close duty timing mode. As shown in FIG. 11, command B2 1110 is illustrated at approximately the 12:00 position of the timing circle 1100. After command B2 1110 may be received by shutter eyewear (not shown in FIG. 11), both the left and right shutters may close as illustrated by section 1120 for a period of time, Tduty 1130.

Next, command A2 1140 may be received by shutter eyewear and is illustrated at approximately the 4:30 position of the timing circle 1100. The left shutter and right shutter may both open or closed, depending on the dual 2D mode selection, for a period of time illustrated by section 1150.

Although periods of time 1160 and 1170 may have elapsed, because an operating mode has not been determined, the left and right shutters may remain open or closed (depending on dual 2D mode selection) through the sections 1160 and 1170 for at least the first cycle of the timing circle 1100. After the shutter eyewear receives the commands B2 1110 and A2 1140 for a couple of cycles, in which the commands are substantially stable and spaced in time as illustrated by the timing circle 1100, the shutter eyewear may determine a mode of operation. Once the operating mode is determined, then a symmetric implied B2 point 1142, also labeled Tclose-both2, may be implied across the timing circle at approximately Tperiod/2. Stated differently, at implied B2 point 1142, no additional command may be received; however both the left and right shutter may be closed for the section 1160 for a time period of Tduty 1135. Further, a symmetric implied A2 point 1112, also labeled Topen-both2, may be implied across the timing circle at the 10:30 position. At implied A2 point 1112, again although no additional command may be received, both the left and right shutter may be open or closed (depending on dual 2D mode selection) for the section 1170.

Continuing the discussion of FIG. 11, command B2 1110 may be received after the point 1146, also labeled Tclose-both1, where the shuttering action may take place. Although the point 1146 may be the point at which the shuttering action occurs, the command B2 1140 may not be received for a Tdelay 1145 time period. Stated differently, although the command B2 1140 may not have been received, the operating mode may allow the shuttering action to be implied before the command may actually be received.

The table 1180 is also shown in FIG. 11. The table 1180 includes approximate time periods for functions that occur in the symmetrical dual 2D with long close duty timing mode and demonstrates that the time periods for functions may depend on the relative timing locations relative. As shown in FIG. 11, Tperiod may be approximately the Time B2(n)−Time B2(n-1). Stated differently, Tperiod may be approximately the time between receiving a first command B2 and a second command B2. Also in table 1180, Tdelay may be approximately Tperiod/16. Furthermore, both the right and left shutter may close at a 12:00 position, or as labeled on the timing circle 1100 the Tclose-both1 position. This first position in time may be defined approximately by the time at which the B2 command 1110 is received minus the Tdelay 1145. The second position labeled as Topen-both1 on the timing circle 1100 may be the time at which both the left and right shutter may open or closed depending on the dual 2D mode selection. The second position may be defined approximately by the time at which Tclose-both1 position occurs plus Tduty 1130. The third position on the timing circle 1100 labeled as Tclose-both2 at the 6:00 position, may be defined approximately by the time at which the Tclose-both1 position occurs plus Tperiod/2. The fourth position on the timing circle 1100 labeled as Topen-both2 may be the approximate time at which both the left and right shutter may open or close depending on the dual 2D mode selection. The fourth position may be defined approximately by the time at which the second command Topen-both1 occurs plus Tperiod/2. The dual 2D mode selection may determine whether a viewer may be seeing Image 1 in the 12:00-6:00 position of the timing circle 1100 or Image 2 in the 6:00-12:00 position of the timing circle.

Still continuing with FIG. 11, the conceptual timing dependence for the symmetrical dual 2D with long close duty timing mode is approximately defined. The conceptual timing dependence for this mode may be defined such that [Time A2(n)−Time B2(n)]>Tperiod/2. As previously mentioned, the A2 command may be received between the 12:00-6:00 positions of the timing circle 1100 and the conceptual timing dependence illustrates the dependence of the mode on the type of command received as well as the time at which it was received. Additionally, the “specific timing requirements” for Mode 6 are included in FIG. 11 and may be defined as Time A2(n)>[Time B2(n)+2*Tcommand] and Time A2(n)<[Time B2(n)+Tperiod/2−2*Tdelay]. Tcommand may be the command timing and may be the transit time for each command, which may be approximately equal relative to whether short or long encoding may be selected. Further the actual transit time may be approximately 305 microseconds for short command encoding and approximately 1220 microseconds for long command encoding. Tduty may be set forth for Mode 6 as Time A2(n)−Time B2(n)+2*Tdelay.

In the example of FIG. 11, since Mode 6 is a symmetrical mode, the commands B2 and A2 may imply functions to take place at a time Tperiod/2 across the timing circle from the point at which the commands B2 and A2 were actually received. Additionally, because A2 arrives between the 12:00 and 6:00 positions on the timing circle, the operating mode may be in 2D. Moreover, the long close duty timing may be indicated by looking to the locations of the Tdelay time periods. As command A2 moves closer in time clockwise to implied command B2 at point 1142, keeping in mind A2 may stay between 12:00-6:00 on the timing circle, commands B2 and A2 may be minimally separated in time that may be less than Tdelay. However, as command A2 moves closer in time counterclockwise to the 12:00 position on the timing circle, Tduty 1130 may become smaller and may be limited by the Tdelay times associated with the commands in the command sequence. In one example of Mode 6, a minimum Tduty may be larger than a time duration of 2*Tdelay. Since all except the single command modes may have two timing methods, long and short closed duty, there may no longer be any “holes” in the duty due to the Tdelay times that accompany the commands and period options due to command timing restrictions. In the example of FIG. 11, Tduty 1130 may transition at location 1142 over to Tduty 1135 within a time period less than Tdelay 1155.

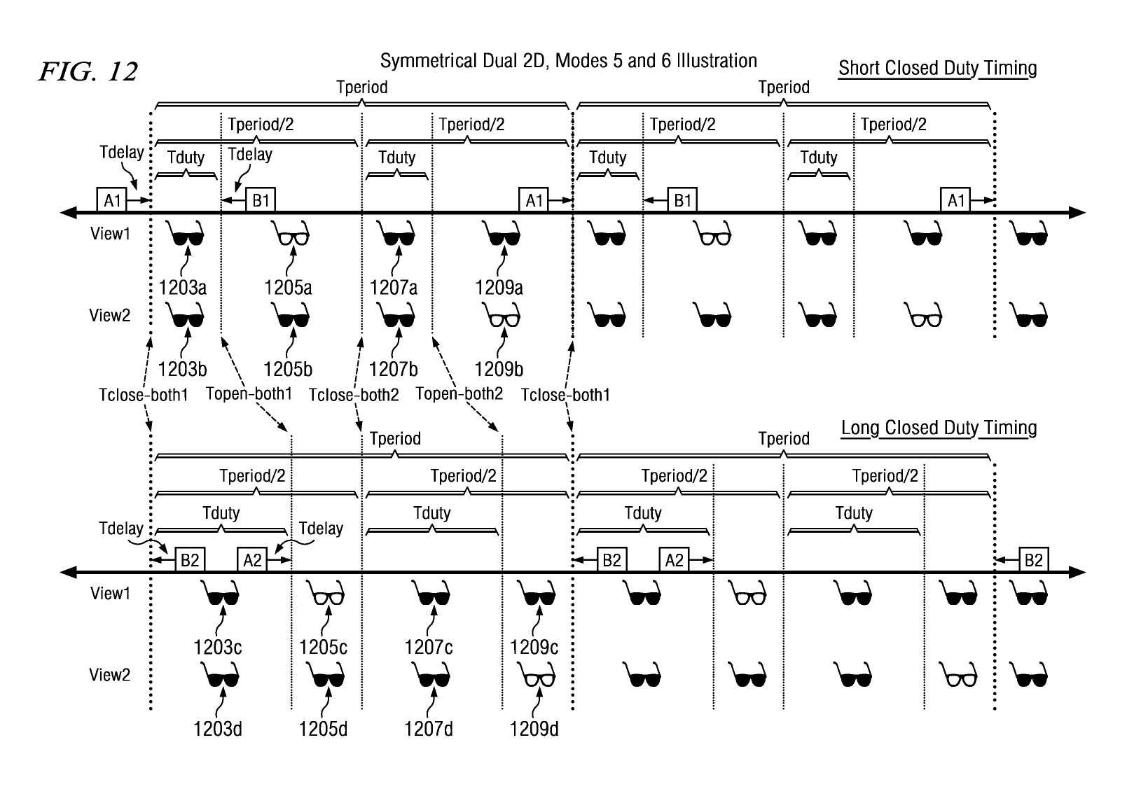

FIG. 12 is a schematic diagram of another embodiment of a timing diagram. Similar to FIGS. 10 and 11, FIG. 12 illustrates two modes, Mode 5 and Mode 6, in the form of a timing diagram. The timing diagram 1200 of Mode 5 illustrates the shutter timing and includes many of the same descriptive elements as the timing circle 1000 of FIG. 10. For example, FIG. 12 includes the approximate time periods for functions that occur in the symmetrical dual 2D with short close duty timing. More specifically, FIG. 12 includes Tduty, Tperiod, Tclose-both1, Topen-both1, Tclose-both2, Topen-both2, Tdelay, and so on. Furthermore, FIG. 12 includes shutter eyewear 1203a and 1203b, 1205a and 1205b, 1207a and 1207b, and 1209a and 1209b, which depict both left and right shutters closed, a period of time in which both the left and right shutters may be open or closed depending on the dual 2D mode selection, both left and right shutters closed and both the left and right shutters may be open or closed depending on the dual 2D mode selection, respectively. Shutter eyewear 1203a and 1203b appears in FIG. 10 in a time period analogous to section 1020. Likewise, shutter eyewear 1205a and 1205b appears in a time period analogous to section 1050 of FIG. 10, and so on.

FIG. 12 also includes Mode 6 in the form of a timing diagram. The timing diagram 1250 of Mode 6 illustrates the shutter timing and includes many of the same descriptive elements as the timing circle 1100 of FIG. 11. For example, FIG. 12 includes the approximate time periods for functions that occur in the symmetrical dual 2D with short close duty timing. More specifically, FIG. 12 includes Tduty, Tperiod, Tclose-both1, Topen-both1, Tclose-both2, Topen-both2, Tdelay, and so on. Furthermore, FIG. 12 includes shutter eyewear 1203c and 1203d, 1205c and 1205d, 1207c and 1207d, and 1209c and 1209d, which depict both left and right shutters closed, a period of time in which both the left and right shutters may be open or closed depending on the dual 2D mode selection, both left and right shutters closed and both the left and right shutters may be open or closed depending on the dual 2D mode selection, respectively. Shutter eyewear 1203c and 1203d appears in FIG. 11 in a time period analogous to section 1120. Likewise, shutter eyewear 1205c and 1205d appears in a time period analogous to section 1150 of FIG. 11, and so on.

FIG. 12 depicts shutter eyewear 1203a, 1205a, 1207a, and 1209a for a view 1 and shutter eyewear 1203b, 1205b, 1207b, and 1209b for a view 2. View 1 of FIG. 12 may view an Image 1 in section 1050 of FIG. 10 and View 2 of FIG. 12 may view an Image 2 in section 1070 of FIG. 10. A similar logic may apply between FIGS. 11 and 12.

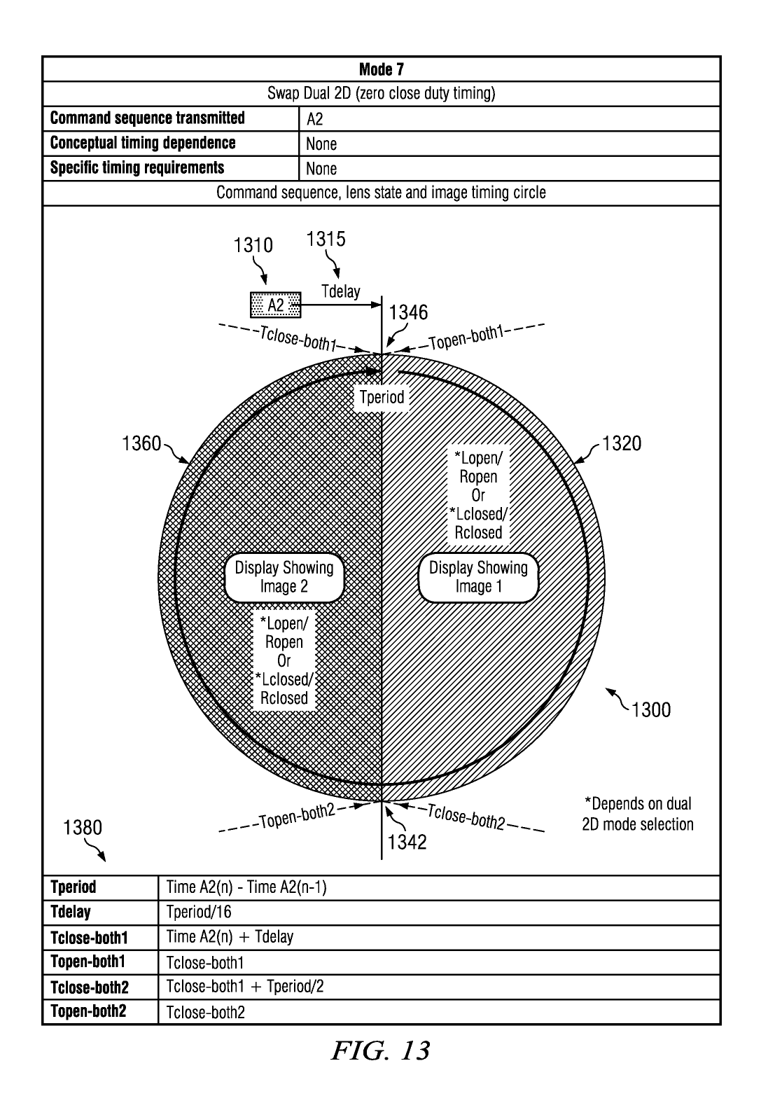

FIG. 13 is a schematic diagram of another embodiment of an image timing circle 1300. Mode 7 is illustrated in the image timing circle 1300 and Mode 7 may be specified by the command sequence A2 and the timing locations as shown in FIG. 13. Mode 13 may also be referred to herein as swap dual 2D (zero close duty timing) mode. As shown in FIG. 13, command A2 1310 is illustrated at approximately the 12:00 position of the timing circle 1300. After command A2 1310 may be received by shutter eyewear (not shown in FIG. 13) and a time of Tdelay 1315 may elapse, both the left and right shutters may open or close depending on the dual 2D mode selection, as illustrated by section 1320 for a period of time. During section 1320 Image 1 may be viewed.

Although period of time 1360 may have elapsed, because an operating mode may not have been determined yet, the left and right shutters may remain open or closed (depending on the dual 2D mode selection), through the section 1360 for at least the first cycle of the timing circle 1300. After the shutter eyewear receives the command A2 1310 for a couple of cycles, in which the command is substantially stable and spaced in time as illustrated by the timing circle 1300, the shutter eyewear may determine a mode of operation. Once the operating mode is determined, then a symmetric A2 point 1342, also labeled both Tclose-both2 and Topen-both2, may be implied across the timing circle. Stated differently, at A2 point 1342, no additional command may be received; however the shuttering of the eyewear may switch for the section 1360. To clarify, in section 1320 if both shutters are open, then the shutters may close for section 1360 and if both shutters are closed for section 1320, then both the shutters may open for section 1360.

Continuing the discussion of FIG. 13, command A2 1310 may be received before the A2 point 1346, also labeled both Tclose-both1 and Topen-both1, where the shuttering action may take place. Although the A2 point 1346 may be the point at which the shuttering action occurs, the shuttering action may not occur until the command A2 1340 may be received and a Tdelay 1315 time period elapses following the A2 point 1346.

The table 1380 is also shown in FIG. 13. The table 1380 includes approximate time periods for functions that occur in the swap dual 2D (zero close duty timing) mode and demonstrates that the time periods for functions may depend on the relative timing locations relative. As shown in FIG. 13, Tperiod may be approximately the Time A2(n)−Time A2(n-1). Stated differently, Tperiod may be approximately the time between receiving a first command A2 and a second command A2. Also in table 1380, Tdelay may be approximately

Tperiod/16. Furthermore, both the right and left shutter may open or close, depending on the dual 2D mode selection at a 12:00 position, or at point 1346 labeled both Tclose-both1. This first position in time, Tclose-both1, may be defined approximately by the time at which the A2 command 1310 is received plus the Tdelay 1315. The second position labeled as Topen-both1 on the timing circle 1300 (also at point 1346), may be defined approximately by the time at which Tclose-both1 position occurs. The third position on the timing circle 1300 labeled as Tclose-both2 at the 6:00 position, may be defined approximately by the time at which the Tclose-both1 position occurs plus Tperiod/2. The fourth position on the timing circle 1300 labeled as Topen-both2 (and which also appears at approximately the 6:00 position), may be defined approximately by the time at which the second command Topen-both2 occurs.

Still continuing with FIG. 13, the conceptual timing dependence and the specific timing requirements for the swap dual 2D (zero close duty timing) mode need not be defined.

In the example of FIG. 13, since Mode 7 is a swap mode, both lenses may be in substantially similar lens positions. For example, both the left and right shutters may be open or closed at substantially the same time, but the left shutter may not be open while the right shutter is closed and vice versa. Additionally, the zero close duty timing may be indicated by looking to the absence of the close duty or Tduty periods. Since Mode 7 is a zero close duty timing mode, there may no longer be any “holes” in the duty due to the Tdelay times that accompany the commands and period options due to command timing restrictions.

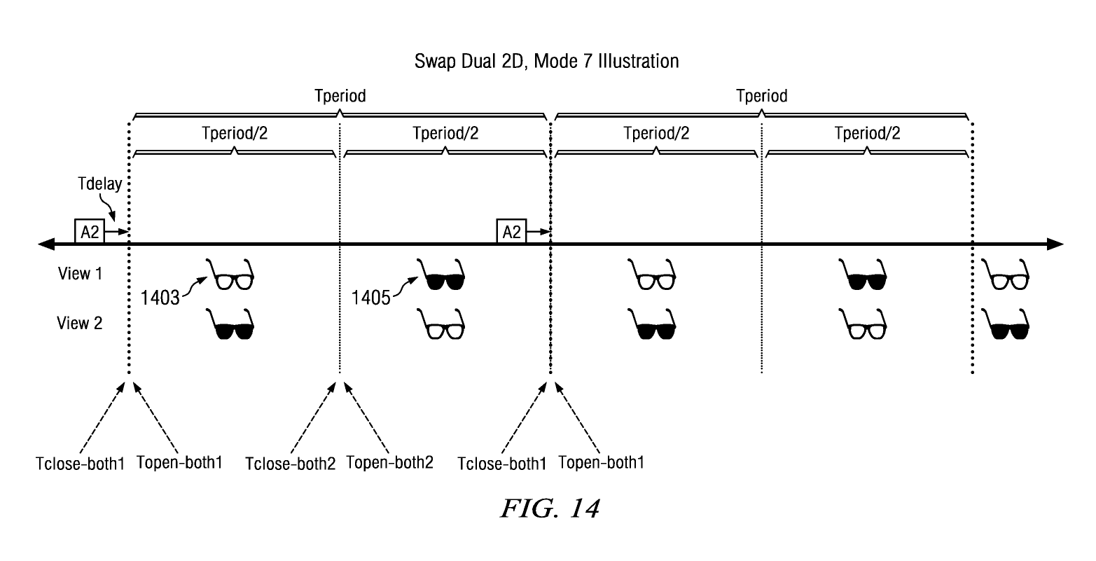

FIG. 14 is a schematic diagram of another embodiment of a timing diagram. Similar to FIG. 13, FIG. 14 illustrates Mode 4, except in the form of a timing diagram. The timing diagram 1400 of Mode 7 illustrates the shutter timing and includes many of the same descriptive elements as the timing circle 1300 of FIG. 13. For example, FIG. 14 includes the approximate time periods for functions that occur in the swap dual 2D mode. More specifically, FIG. 14 includes Tperiod, Tclose-both1, Tclose-both2, Tdelay, and so on. Furthermore, FIG. 14 includes shutter eyewear 1403 and 1405 which depict both the left and right shutters open or close together, depending on the dual 2d mode selection, and both the left and right shutters switch to the opposite shuttering, respectively. Shutter eyewear 1403 appears in FIG. 14 in a time period analogous to section 1320 of FIG. 13. Likewise, shutter eyewear 1405 appears in a time period in FIG. 14 analogous to section 1360 of FIG. 13, and so on.

FIG. 14 depicts shutter eyewear 1403a and 1403b, for a view 1 and shutter eyewear 1405a and 1405b, for a view 2. View 1 of FIG. 14 may view an Image 1 in section 1320 of FIG. 13 and View 2 of FIG. 14 may view an Image 2 in section 1360 of FIG. 13.

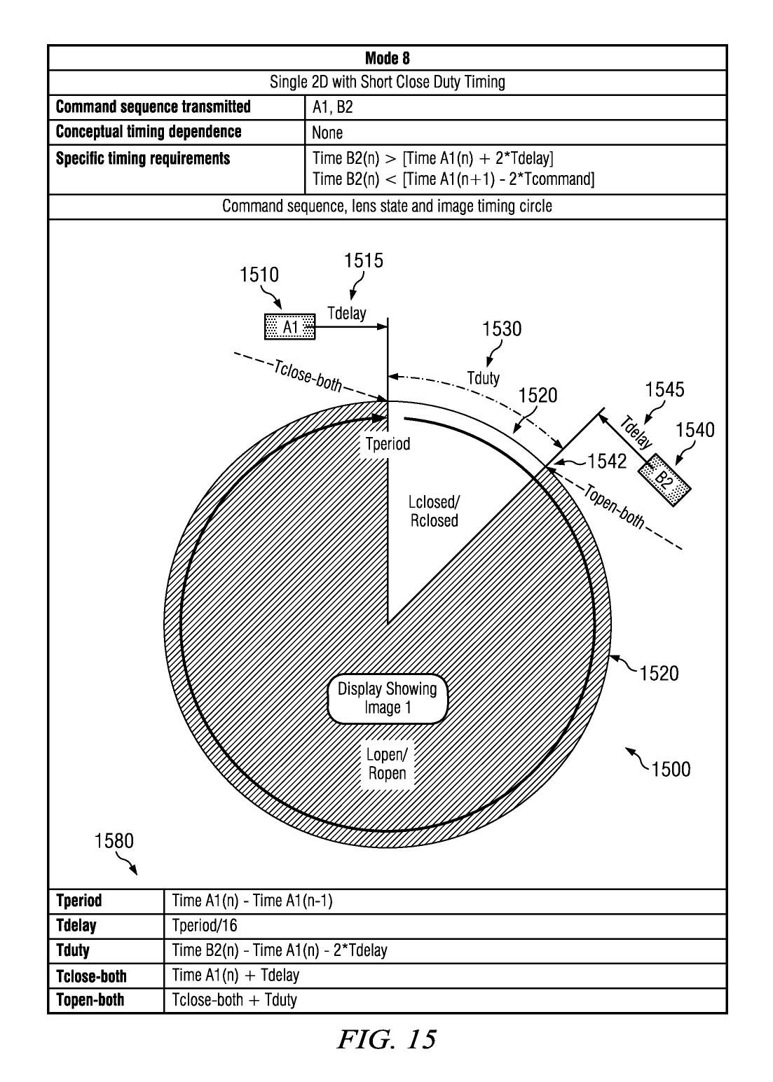

FIG. 15 is a schematic diagram of another embodiment of an image timing circle 1500 which illustrates Mode 8. Mode 8 may be specified by the command sequence A1, B2 and the timing locations illustrated in the timing circle 1500. Mode 8 may also be referred to herein as Single 2D with short close duty timing. As shown in FIG. 15, command A1 1510 is illustrated at approximately the 12:00 position of the timing circle 1500. After command A1 1510 may be received by shutter eyewear (not shown in FIG. 15) and a time of Tdelay 1515 may elapse, both the left and right shutters may close as illustrated by section 1520 for a period of time, Tduty 1530. Next, command B2 1540 may be received by shutter eyewear and is illustrated at approximately the 2:30 position of the timing circle 1500. Both the left and right shutter may open substantially at the same time and an Image 1 may be viewed through the left and right shutters for a period of time illustrated by section 1550.

As shown in FIG. 15, the command B2 1540 was not received until the 2:30 position illustrated in timing circle 1500, and the left and right shutters may remain closed past the point 1542, also labeled Topen-both for a delay of approximately Tdelay 1545, for at least the first cycle of the timing circle 1500. After the shutter eyewear receives the commands A1 1510 and B2 1540 for a couple of cycles, in which the commands are substantially stable and spaced in time as illustrated by the timing circle 1500, the shutter eyewear may determine a mode of operation. Once the operating mode is determined, then the shuttering action may take place at 1542 as shown in the timing circle 1500. Stated differently, even though the shuttering action is illustrated as occurring at point 1542, for the first couple of cycles, the shuttering action may not take place for at least a time delay, Tdelay 1545 past the point 1542.

Continuing the discussion of FIG. 5, command B2 1540 may be received after the point 1542, also labeled Topen-both, where the shuttering action may take place. Although the B2 point 1542 may be the point at which the shuttering action occurs, the command B2 1540 may not be received until a Tdelay 1545 time period elapses following the point 1542. Stated differently, although the command B2 1540 may not have been received, the operating mode may allow the shuttering action to be implied before the command may actually be received.

The table 1580 is also shown in FIG. 15. The table 1580 includes approximate time periods for functions that occur in the single 2D with short close duty timing mode and demonstrates that the time periods for functions may depend on the relative timing locations relative. As shown in FIG. 15, Tperiod may be approximately the Time A1(n)−Time A1(n−1). Stated differently, Tperiod may be approximately the time between receiving a first command A1 and a second command A1. Also in table 1580, Tdelay may be approximately Tperiod/16. Furthermore, both the right and left shutter may close at a 12:00 position, or as labeled on the timing circle 1500 the Tclose-both position. This first position in time may be defined approximately by Time A1(n)+Tdelay or the time at which the A1 command 1510 is received plus the Tdelay 1515. The second position labeled as Topen-both on the timing circle 1500 may be the time at which both the left and right shutters may open. The second position may be defined approximately by the time at which Tclose-both position occurs plus Tduty. Tduty may be approximately defined as Time B2(n)−Time A1(n)−2*Tdelay.

Still continuing with FIG. 15, the conceptual timing dependence for the single 2D with short close duty timing mode need not be defined for Mode 8. Additionally, the specific timing requirements for Mode 8 are included in FIG. 15 and may be defined as Time B2(n)>[Time A1(n)+2*Tdelay] and Time B2(n)<[Time A1(n+1)−2*Tcommand]. Tcommand may be the command timing and may be the transit time for each command, which may be approximately equal relative to whether short or long encoding may be selected. Further the actual transit time may be approximately 305 microseconds for short command encoding and approximately 1220 microseconds for long command encoding.

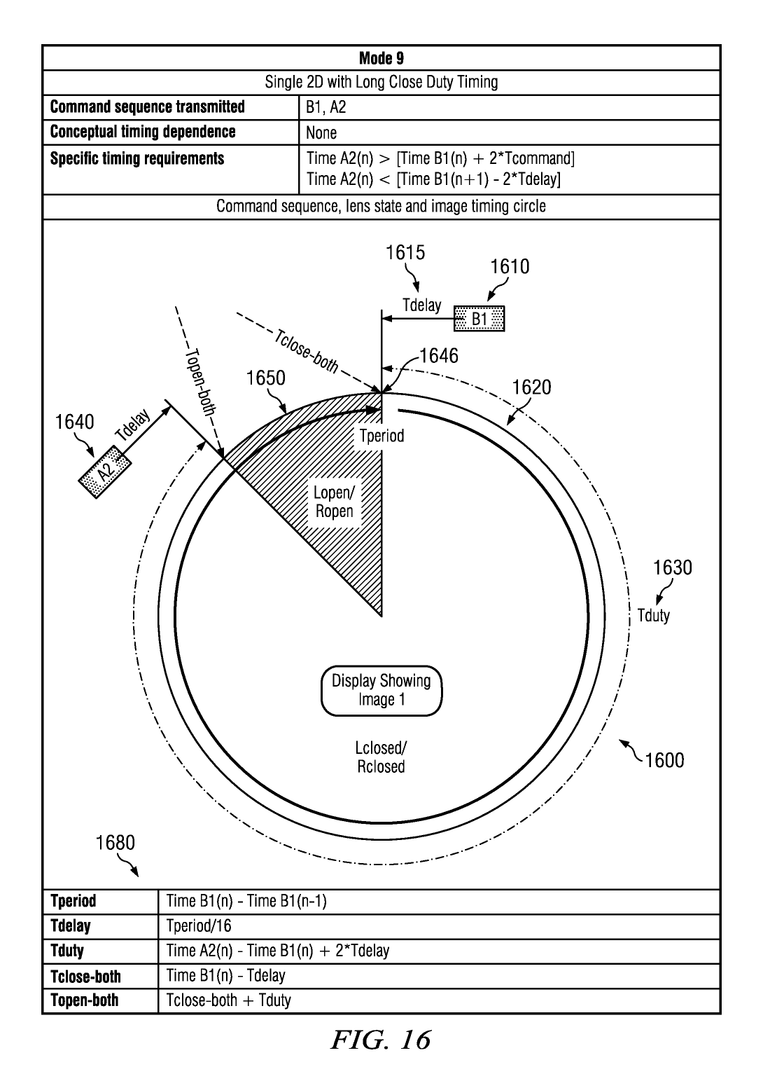

FIG. 16 is a schematic diagram of another embodiment of an image timing circle 1600 of Mode 9, which may be specified by the command sequence B1, A2 and the timing locations as shown in FIG. 16. Mode 9 may also be referred to herein as single 2D with long close duty timing mode. As shown in FIG. 16, command B1 1610 is illustrated at approximately the 12:00 position of the timing circle 1600. After command B1 1610 may be received by shutter eyewear (not shown in FIG. 16), both the left and right shutters may close as illustrated by section 1620 for a period of time, Tduty 1630. Next, command A2 1640 may be received by shutter eyewear and is illustrated at approximately the 10:30 position of the timing circle 1600. Both the left and right shutters may open at substantially the same time and an Image 1 may be viewed through both the left and right shutters for a period of time illustrated by section 1650.

Although the commands B1 1610 and A2 1640 may be received for the first couple of cycles, an operating mode may not yet be determined. After the shutter eyewear receives the commands B1 1610 and A2 1640 for a couple of cycles, in which the commands are substantially stable and spaced in time as illustrated by the timing circle 1600, the shutter eyewear may determine a mode of operation. Once the operating mode is determined, then the shuttering action may take place at point 1646 even though the command B1 1610 may not be received for a period of time Tdelay 1615. Stated differently, at point 1646, the command may not yet be received, however the left and right shutters may close for the section 1620 as the operating mode may imply the shuttering action even though the command has not been received. Continuing the discussion of FIG. 16, command B1 1610 may be received after the point 1646, also labeled Tclose-both, where the shuttering action may take place. Although the point 1646 may be the point at which the shuttering action occurs, the command B1 1610 may not be received until a Tdelay 1615 time period elapses following the point 1646. Stated differently, although the command B1 1610 may not have been received, the operating mode may allow the shuttering action to be implied before the command may actually be received.

The table 1680 is also shown in FIG. 16. The table 1680 includes approximate time periods for functions that occur in the single 2D with long close duty timing and demonstrates that the time periods for functions may depend on the relative timing locations relative. As shown in FIG. 16, Tperiod may be approximately the Time B1(n)−Time B1(n-1). Stated differently, Tperiod may be approximately the time between receiving a first command B1 and a second command B1. Also in table 1680, Tdelay may be approximately Tperiod/16. Furthermore, both the right and left shutter may close at a 12:00 position, or as labeled on the timing circle 1600 the Tclose-both position. This first position in time may be defined approximately by the time at which the B1 command 1610 is received minus the Tdelay 1615. The second position labeled as Topen-both on the timing circle 1600 may be the time at which the left and right shutters may open. The second position may be defined approximately by the time at which Tclose-both position occurs plus Tduty. Tduty may be an approximate time of Time A2(n)−Time B1(n)+2*Tdelay.

Still continuing with FIG. 16, the conceptual timing dependence for the single 2D with long close duty timing mode need not be discussed. Additionally, the “specific timing requirements” for Mode 9 are included in FIG. 16 and may be defined as Time A2(n)>[Time B1(n)+2*Tcommand] and Time A2(n)<[Time B1(n+1)−2*delay]. Tcommand may be the command timing and may be the transit time for each command, which may be approximately equal relative to whether short or long encoding may be selected. Further the actual transit time may be approximately 305 microseconds for short command encoding and approximately 1220 microseconds for long command encoding.

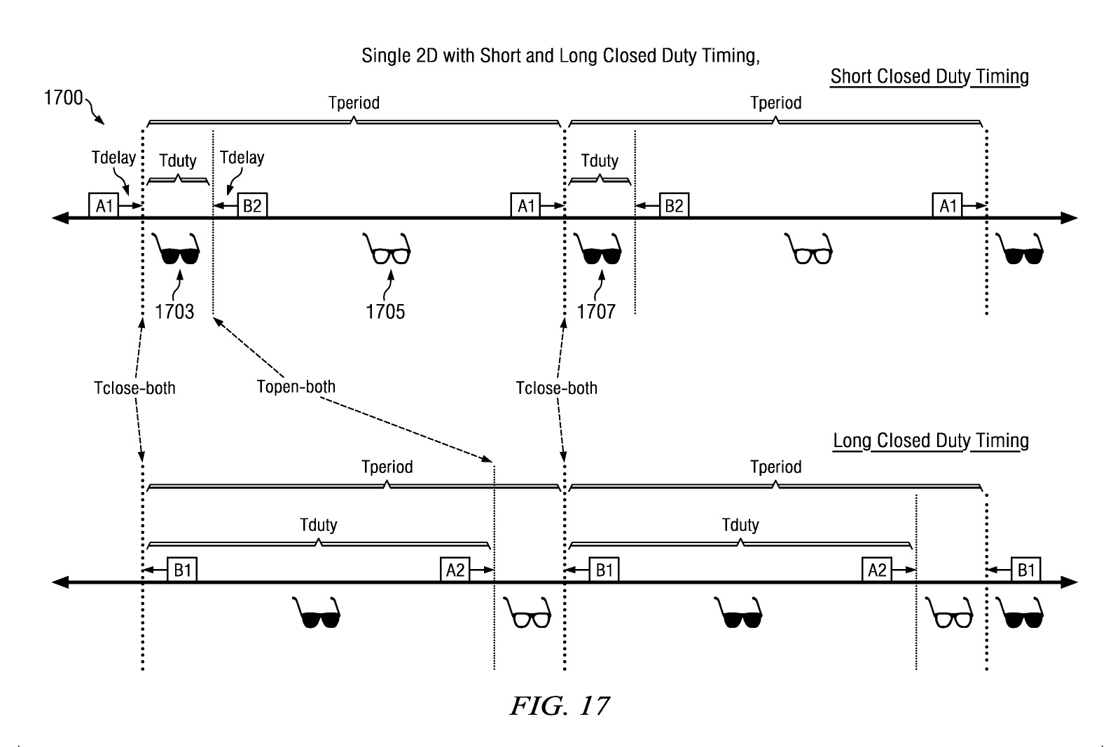

FIG. 17 is a schematic diagram of another embodiment of a timing diagram. Similar to FIGS. 15 and 16, FIG. 17 illustrates two modes, Mode 8 and Mode 9, in the form of a timing diagram. The timing diagram 1700 of Mode 8 illustrates the shutter timing and includes many of the same descriptive elements as the timing circle 1500 of FIG. 15. For example, FIG. 17 includes the approximate time periods for functions that occur in the single 2D with short close duty timing mode. More specifically, FIG. 17 includes Tduty, Tperiod, Tclose-both, Topen-both, and so on. Furthermore, FIG. 17 includes shutter eyewear 1703, 1705, and 1707 which depict both left and right shutters closed, both left and right shutters open, and then both left and right shutters closed again, respectively. Shutter eyewear 1703 appears in FIG. 17 in a time period analogous to section 1520 of FIG. 15. Likewise, shutter eyewear 1705 of FIG. 17 appears in a time period analogous to section 1550 of FIG. 15, shutter eyewear 1707 of FIG. 17 appears again in a “second” cycle of section 1520 of FIG. 15 and so on. A similar logic may apply between FIGS. 16 and 17.

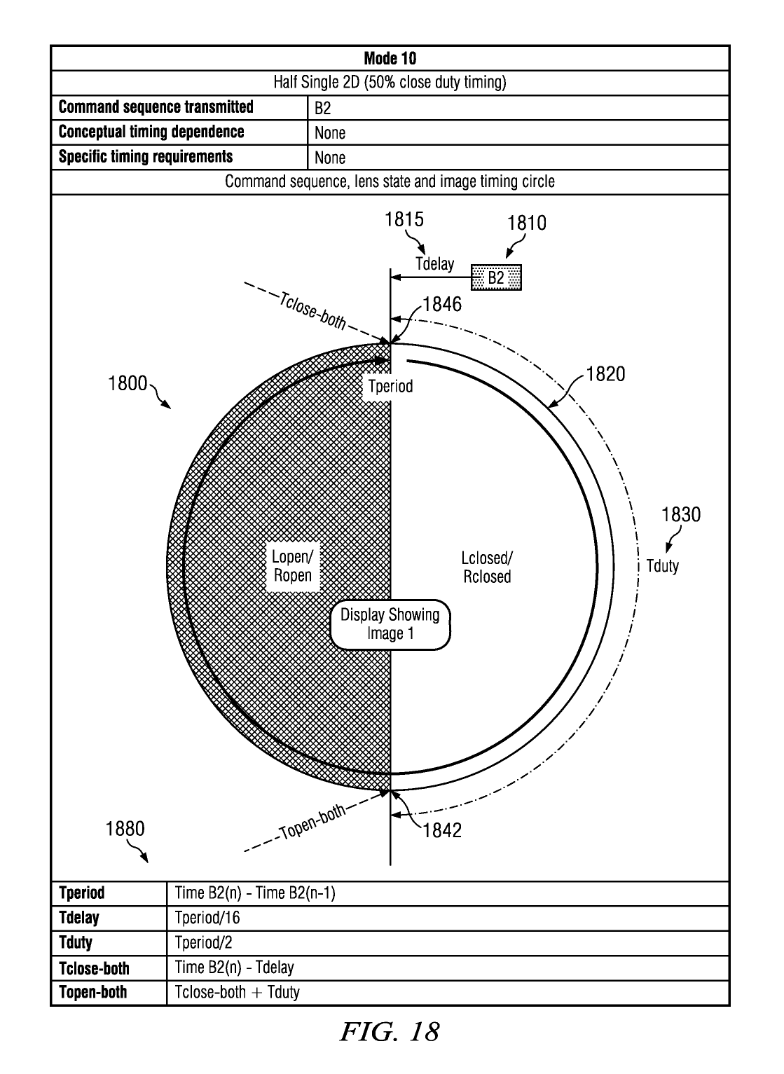

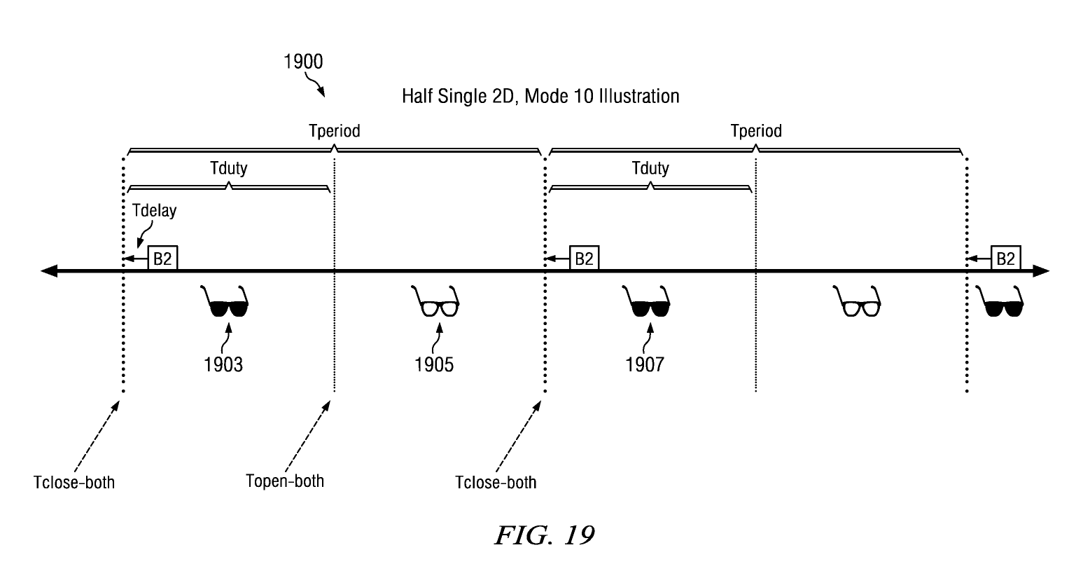

FIG. 18 is a schematic diagram of another embodiment of an image timing circle 1800 of Mode 10 and may be specified by the command sequence B2 and the timing locations as shown in FIG. 18. Mode 10 may also be referred to herein as the half single 2D (50% close duty) timing mode. As shown in FIG. 10, command B2 1810 is illustrated at approximately the 12:00 position of the timing circle 1800. Command B2 1810 may be received by shutter eyewear (not shown in FIG. 18) and both the left and right shutters may close as illustrated by section 1820 for a period of time, Tduty 1830.

Although a period of time 1860 may have elapsed, because an operating mode may not yet be determined, the left and right shutters may remain closed through the section 1860 for at least the first cycle of the timing circle 1800. After the shutter eyewear receives the command B2 1810 for a couple of cycles, in which the command is substantially stable and spaced in time as illustrated by the timing circle 1800, the shutter eyewear may determine a mode of operation. Once the operating mode is determined, then a symmetric B2 point 1842, also labeled Topen-both, may be implied across the timing circle. Stated differently, at point 1842, no additional command may be received, however the left and right shutters may open for the section 1860.

Continuing the discussion of FIG. 18, command B2 1810 may be received after the B2 point 1846, also labeled Tclose-both, where the shuttering action may take place. Although the B2 point 1846 may be the point at which the shuttering action occurs, the command B2 1810 may not be received until a Tdelay 1815 time period elapses following the B2 point 1846. Stated differently, although the command B2 1810 may not have been received, the operating mode may allow the shuttering action to be implied before the command may actually be received.

The table 1880 is also shown in FIG. 18. The table 1880 includes approximate time periods for functions that occur in the half single 2D (50% close duty timing) mode and demonstrates that the time periods for functions may depend on the relative timing locations relative. As shown in FIG. 18, Tperiod may be approximately the Time B2(n)−Time B2(n−1). Stated differently, Tperiod may be approximately the time between receiving a first command B2 and a second command B2. Also in table 1880, Tdelay may be approximately Tperiod/16. Furthermore, both the right and left shutter may close at a 12:00 position, or as labeled on the timing circle 1800 the Tclose-both position. This first position in time may be defined approximately by the time at which the B2 command 1810 is received minus the Tdelay 1815. The second position point 1842, or labeled as Topen-both on the timing circle 1800 may be the approximate time at which the left and right shutters may open. The second position may be approximately the time at which the Tclose-both position occurs plus Tduty. Tduty may be defined as Tperiod/2. Additionally, with respect to FIG. 18, the conceptual timing dependence and the “specific timing requirements” for the half single 2D (50% close duty timing) mode may not be discussed.

FIG. 19 is a schematic diagram of another embodiment of a timing diagram. Similar to FIG. 18, FIG. 19 illustrates Mode 10, in the form of a timing diagram. The timing diagram 1900 of Mode 10 illustrates the shutter timing and includes many of the same descriptive elements as the timing circle 1800 of FIG. 18. For example, FIG. 19 includes the approximate time periods for functions that occur in the half single 2D (50% close duty timing) mode. More specifically, FIG. 19 includes Tduty, Tperiod, Tclose-both, Topen-both, and so on. Furthermore, FIG. 19 includes shutter eyewear 1903, 1905, and 1907 which depict both left and right shutters closed, both left and right shutters open, and then both left and right shutters closed again, respectively. Shutter eyewear 1903 appears in FIG. 19 in a time period analogous to section 1820 of FIG. 18. Likewise, shutter eyewear 1905 of FIG. 19 appears in a time period analogous to section 1860 of FIG. 18. Similarly, shutter eyewear 1907 of FIG. 19 appears again in a “second” cycle of section 1820 of FIG. 18 and so on.

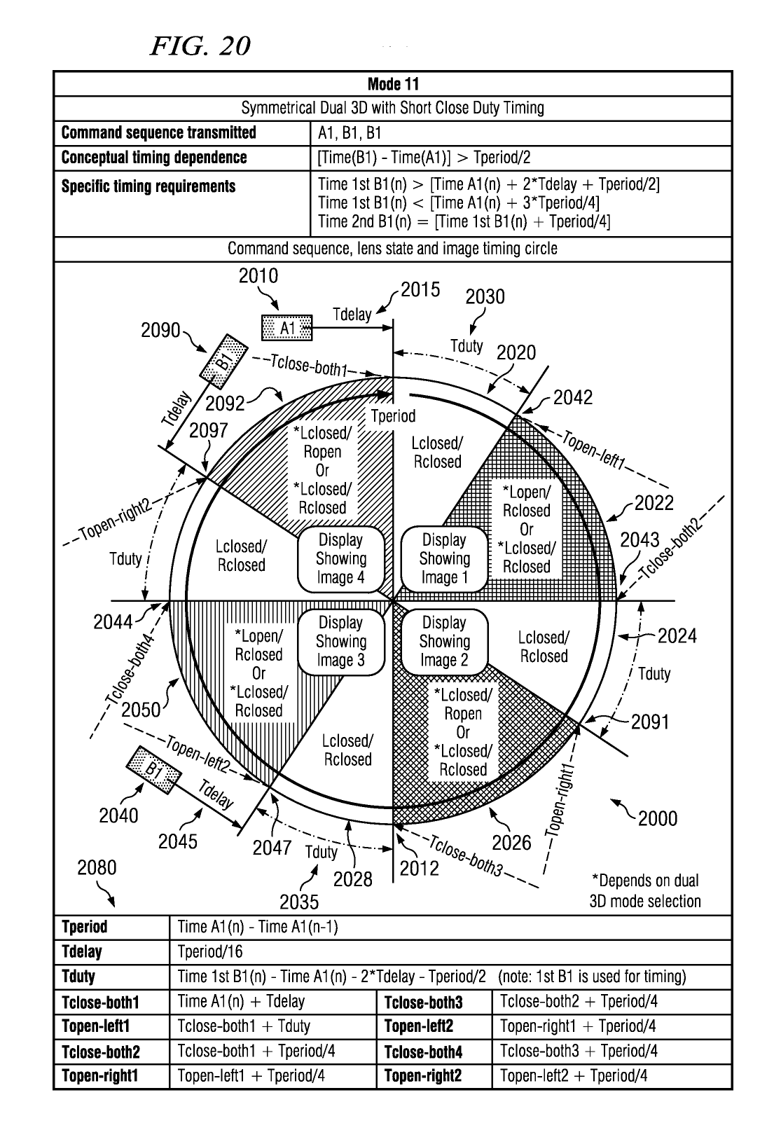

FIG. 20 is a schematic diagram of another embodiment of an image timing circle 2000 and Mode 11, which may be specified by the command sequence A1, B1, B1 and the timing locations as shown in FIG. 20. Mode 11 may also be referred to herein as symmetrical dual 3D with short close duty timing. As shown in FIG. 20, command A1 2010 is illustrated at approximately the 12:00 position of the timing circle 2000. After command A1 2010 may be received by shutter eyewear (not shown in FIG. 20) and a time of Tdelay 2015 may elapse, both the left and right shutters may close as illustrated by section 2020 for a period of time, Tduty 2030. Next, command B1 2040 may be received by shutter eyewear and is illustrated at approximately the 7:30 position of the timing circle 2000. The left shutter may open and right shutter may close, or both shutters may close substantially together, depending on the dual 3D mode selection, and an Image 3 may be viewed through the left shutter for a period of time illustrated by section 2050. Furthermore, because command B1 2040 occurs between the 6:00-12:00 positions of the timing circle 2000, the operating mode may be 3D. Next, a second command B1 2090 may be received by shutter eyewear and is illustrated at approximately the 10:00 position of the timing circle 2000. The left shutter may close and right shutter may open or both shutters may close substantially together, depending on the dual 3D mode selection, and an Image 4 may be viewed through the right shutter for a period of time illustrated by section 2092.

Although periods of time, 2022, 2024, 2026, 2028 may have elapsed, because the command B1 2040 was not received until the 7:30 position illustrated in timing circle 2000, the left and right shutters may remain closed through the sections 2022, 2024, 2026, and 2028 for at least the first cycle of the timing circle 2000. After the shutter eyewear receives the commands A1 2010, B1 2040, and B1 2090 for a couple of cycles, in which the commands are substantially stable and spaced in time as illustrated by the timing circle 2000, the shutter eyewear may determine a mode of operation. Once the operating mode is determined, then a symmetric B1 point 2042, also labeled Topen-left1, may be implied across the timing circle. Stated differently, at B1 point 2042, no additional command may be received, however the left may open or both shutters may close, depending on the dual 3D mode selection, for the section 2022. Further, a symmetric A1 point 2012, also labeled Tclose-both3, may be implied across the timing circle at the 6:00 position. At A1 point 2012, again although no additional command may be received, the left and right shutter may close for the section 2028 for a time period of Tduty 2035. Moreover, a second symmetric B1 point 2091, also labeled Topen-right1, may be implied across the timing circle at approximately the 4:30 position. At B1 point 2091, again although no additional command may be received, the right shutter may open or both shutters may close depending on the dual 3D mode selection, for the section 2026. The A1 command may have three symmetric implied commands all of which may be separated by approximately ¼ Tperiod. These may be implied substantially similarly as the command at the 6:00 position. Since these are quad image commands, conceptually each B1 command may also have three symmetric implied commands. Two B1 commands may be used to distinguish this mode from dual 3D.

Continuing the discussion of FIG. 20, command B1 2040 may be received after the B1 point 2047, also labeled Topen-left2, where the shuttering action may take place. Although the B1 point 2047 may be the point at which the shuttering action occurs, the command B1 2040 may not be received until a Tdelay 2045 time period elapses following the B1 point 2047. Stated differently, although the command B1 2040 may not have been received, the operating mode may allow the shuttering action to be implied before the command may actually be received. Similar logic may apply to the second B1 command 2090.

The table 2080 is also shown in FIG. 20. The table 2080 includes approximate time periods for functions that occur in the symmetrical dual 3D with short close duty timing mode and demonstrates that the time periods for functions may depend on the relative timing locations relative. As shown in FIG. 20, Tperiod may be approximately the Time A1(n)−Time A1(n−1). Stated differently, Tperiod may be approximately the time between receiving a first command A1 and a second command A1. Also in table 2080, Tdelay may be approximately Tperiod/16. Furthermore, both the right and left shutter may close at a 12:00 position, or as labeled on the timing circle 2000 the Tclose-both1 position. This first position in time may be defined approximately by the time at which the A1 command 2010 is received plus the Tdelay 2015. The second position 2042 or labeled as Topen-left1 on the timing circle 2000 may be the time at which the left shutter may open and the right shutter may close or both shutters close, depending on the dual 3D mode selection. The second position may be approximately the time at which Tclose-both1 position occurs plus Tduty 2030. The third position 2043 on the timing circle 2000, also labeled as Tclose-both2 at the 3:00 position, may be approximately the time at which the Tclose-both1 position occurs plus Tperiod/4. The fourth position 2091 on the timing circle 2000 also labeled as Topen-right1 may be approximately the time at which the right shutter may open and the left shutter may close or both shutters close, depending on the dual 3D mode selection. The fourth position may be approximately the time at which the second command Topen-left1 occurs plus Tperiod/4. The fifth position 2012 on the timing circle 2000, also labeled as Tclose-both3 at the 6:00 position, may be approximately the time at which the Tclose-both2 position occurs plus Tperiod/4. The sixth position 2047 on the timing circle 2000 also labeled as Topen-left2 may be approximately the time at which the left shutter may open and the right shutter may close or both shutters close, depending on the dual 3D mode selection. The sixth position 2047 may be approximately the time at which the fourth command Topen-right1 occurs plus Tperiod/4. The seventh position 2044 on the timing circle 2000, also labeled as Tclose-both4 at the 9:00 position, may be approximately the time at which the Tclose-both3 position occurs plus Tperiod/4. The eighth position 2097 on the timing circle 2000 also labeled as Topen-right2 may be approximately the time at which the right shutter may open and the left shutter may close or both shutters close, depending on the dual 3D mode selection. The eighth position 2097 may be approximately the time at which the sixth command Topen-left2 occurs plus Tperiod/4. Additionally, Tduty may be set forth for Mode 11 as Time 1stB1(n)−TimeA1(n)−2*Tdelay−Tperiod/2, and 1^{st} B1 may be used for timing.

Still continuing with FIG. 20, the conceptual timing dependence for the symmetrical dual 3D with short close duty timing mode is approximately set forth. The conceptual timing dependence for this mode may be set forth such that [Time B1(n)−Time A1(n)]>Tperiod/2. As previously mentioned, the B1 command may be received between the 6:00-12:00 positions of the timing circle 2000 and the conceptual timing dependence illustrates the dependence of the mode on the type of command received as well as the time at which it was received. Additionally, the specific timing requirements for Mode 11 are included in FIG. 20 and may be set forth as Time 1^{st} B1(n)>[Time A1(n)+Tperiod/2+2*Tdelay] and Time 1^{st} B1(n)<[Time A1(n)+3*Tperiod/4]. The third “specific timing requirement” may be set forth as, Time 2^{nd} B1(n)=[Time1st B1(n)+Tperiod/4].

In the example of FIG. 20, since Mode 11 is a symmetrical mode, the commands A1 and both B1s may imply functions to take place at a time Tperiod/2 across the timing circle from the point at which the commands A1 and both B1s were actually received. Additionally, because the first B1 command arrives between the 6:00 and 12:00 positions on the timing circle, the operating mode may be in 3D. Moreover, the short close duty timing may be indicated by looking to the locations of the Tdelay time periods. As second command B1 moves closer in time clockwise to command A1, keeping in mind B1 may stay between 6:00-12:00 on the timing circle, commands A1 and B1 may be minimally separated in time by at least 2*Tcommand. However, as the first command B1 moves closer in time to the 6:00 position on the timing circle, Tduty 2035 may become smaller and may not be limited by the Tdelay times associated with the commands in the command sequence. In one example of Mode 11, Tduty may be smaller than the duration of a single Tdelay time. Since all except the single command modes may have two timing methods, long and short closed duty, there may no longer be any “holes” in the duty due to the Tdelay times that accompany the commands and period options due to command timing restrictions.

For symmetrical operational modes, we may assume that most, if not all, the images may have substantially the same period, duty, and phase alignment. This allows us to determine the approximate timing for the images with just one period, duty, and phase being communicated with the commands. Separate operational modes may be used for asymmetrical image periods and duties which will be or have been discussed in further detail.

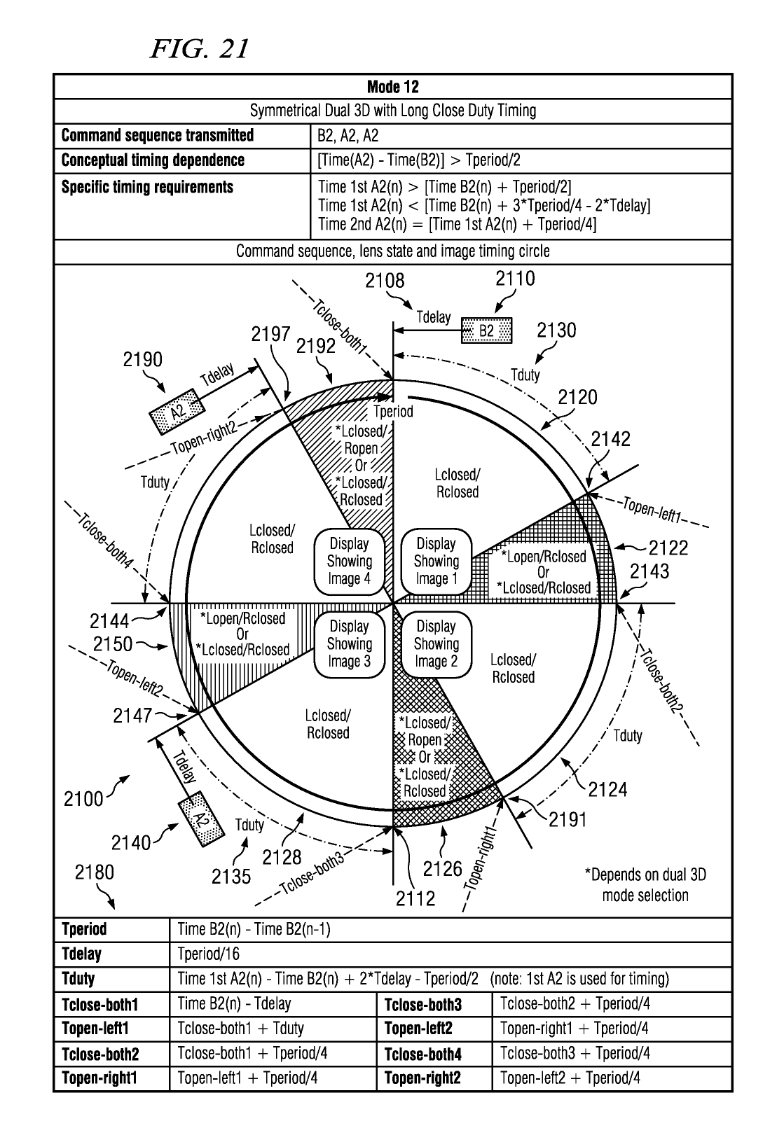

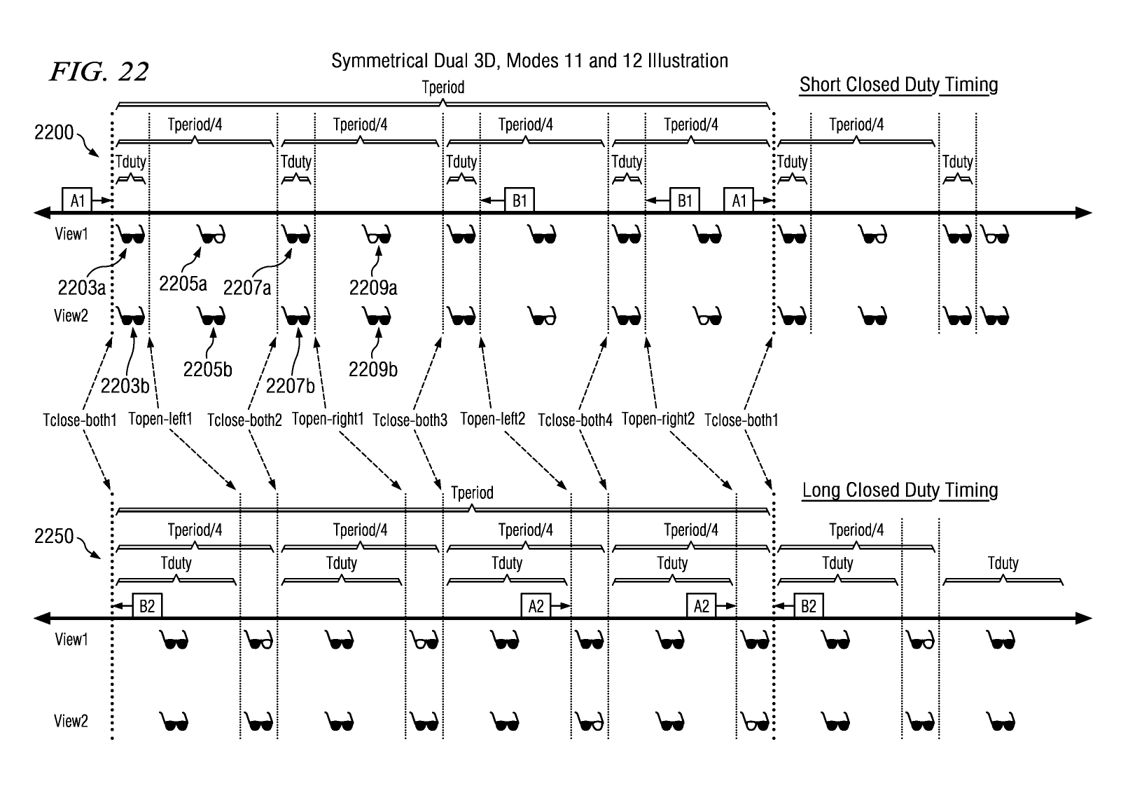

FIG. 21 is a schematic diagram of another embodiment of an image timing circle 2100 and Mode 12, which may be specified by the command sequence B2, A2, A2 and the timing locations as shown in FIG. 21. Mode 12 may also be referred to herein as symmetrical dual 3D with long close duty timing. As shown in FIG. 21, command B2 2110 is illustrated at approximately the 12:00 position of the timing circle 2000. After command A1 2010 may be received by shutter eyewear (not shown in FIG. 21) and both the left and right shutters may close as illustrated by section 2120 for a period of time, Tduty 2130. Next, command A2 2140 may be received by shutter eyewear and is illustrated at approximately the 8:00 position of the timing circle 2100. The left shutter may open and the right shutter may close or both shutters close depending on the dual 3D mode selection, and an Image 3 may be viewed through the left shutter for a period of time illustrated by section 2150. Next, a second command A2 2190 may be received by shutter eyewear and is illustrated at approximately the 11:00 position of the timing circle 2100. The left shutter may close and the right shutter may open or both shutters may close, depending on the dual 3D mode selection, and an Image 4 may be viewed through the and right shutter for a period of time illustrated by section 2192.

Although periods of time, 2122, 2124, 2126, 2128 may have elapsed, because the command A2 2140 was not received until the 7:30 position illustrated in timing circle 2100, the left and right shutters may remain closed through the sections 2122, 2124, 2026, and 2128 for at least the first cycle of the timing circle 2100. After the shutter eyewear receives the commands B2 2110, A2 2140, and A2 2190 for a couple of cycles, in which the commands are substantially stable and spaced in time as illustrated by the timing circle 2100, the shutter eyewear may determine a mode of operation. Once the operating mode is determined, then a symmetric A2 point 2142, also labeled Topen-left1, may be implied across the timing circle. Stated differently, at implied A2 point 2142, no additional command may be received, however the left shutter may open and right shutter may close or both shutters close, depending on the dual 3D mode selection, for the section 2122. Further, a symmetric implied B2 point 2112, also labeled Tclose-both3, may be implied across the timing circle at the 6:00 position. At implied B2 point 2112, again although no additional command may be received, the left and right shutter may close for the section 2128 for a time period of Tduty 2135. Moreover, a second symmetric A2 point 2191, also labeled Topen-right1, may be implied across the timing circle at approximately the 5:00 position. At A2 point 2191, again although no additional command may be received, the left shutter may close and right shutter may open or both shutters close depending on the dual 3D mode selection, for the section 2126. The B2 command may have three symmetric implied commands all of which may be separated by approximately ¼ Tperiod. these commands may be implied substantially similarly as the command at the 6:00 position. Since these are quad image commands, conceptually each A2 command may also have three symmetric implied commands. Two B2 commands may be used to distinguish this mode from dual 3D.

Continuing the discussion of FIG. 21, command B2 2110 may be received after the B2 point 2108, also labeled Tclose-both1, where the shuttering action may take place. Although the B2 point 2108 may be the point at which the shuttering action occurs, the command B2 2110 may not be received until a Tdelay 2115 time period elapses following the B2 point 2108. Stated differently, although the command B2 2110 may not have been received, the operating mode may allow the shuttering action to be implied before the command may actually be received.

The table 2180 is also shown in FIG. 21. The table 2180 includes approximate time periods for functions that occur in the symmetrical dual 3D with long close duty timing mode and demonstrates that the time periods for functions may depend on the relative timing locations. As shown in FIG. 21, Tperiod may be approximately the Time B2(n)−Time B2 (n−1). Stated differently, Tperiod may be approximately the time between receiving a first command B2 and a second command B2. Also in table 2180, Tdelay may be approximately Tperiod/16. Furthermore, both the right and left shutter may close at a 12:00 position, or as labeled on the timing circle 2000 the Tclose-both1 position 2108. This first position in time may be defined approximately by the time at which the B2 command 2110 is received minus the Tdelay 2115. The second position 2142 or labeled as Topen-left1 on the timing circle 2100 may be the time at which the left shutter may open and the right shutter may close or both shutters close, depending on the dual 3D mode selection. The second position may be approximately the time at which Tclose-both1 position occurs plus Tduty 2130. The third position 2143 on the timing circle 2100, also labeled as Tclose-both2 at the 3:00 position, may be approximately the time at which the Tclose-both1 position occurs plus Tperiod/4. The fourth position 2191 on the timing circle 2100 also labeled as Topen-right1 may be approximately the time at which the right shutter may open and the left shutter may close or both shutters close, depending on the dual 3D mode selection. The fourth position may be approximately the time at which the second command Topen-left1 occurs plus Tperiod/4. The fifth position 2112 on the timing circle 2100, also labeled as Tclose-both3 at the 6:00 position, may be approximately the time at which the Tclose-both2 position occurs plus Tperiod/4. The sixth position 2147 on the timing circle 2100 also labeled as Topen-left2 may be approximately the time at which the left shutter may open and the right shutter may close or both shutters close, depending on the dual 3D mode selection. The sixth position 2147 may be approximately the time at which the fourth command Topen-right1 occurs plus Tperiod/4. The seventh position 2144 on the timing circle 2100, also labeled as Tclose-both4 at the 9:00 position, may be approximately the time at which the Tclose-both3 position occurs plus Tperiod/4. The eighth position 2197 on the timing circle 2100 also labeled as Topen-right2 may be approximately the time at which the right shutter may open and the left shutter may close or both shutters close, depending on the dual 3D mode selection. The eighth position 2197 may be approximately the time at which the sixth command Topen-left2 occurs plus Tperiod/4. Additionally, Tduty may be set forth for Mode 12 as Time 1stA2(n)−Time B2(n)+2*Tdelay−Tperiod/2, and 1^{st} A2 may be used for timing.

Still continuing with FIG. 21, the conceptual timing dependence for the symmetrical dual 3D with long close duty timing mode is approximately set forth. The conceptual timing dependence for Mode 12 may be set forth such that [Time A2(n)−Time B2(n)]>Tperiod/2. As previously mentioned, conceptual timing dependence illustrates the dependence of the mode on the type of command received as well as the time at which it was received. Additionally, the specific timing requirements for Mode 12 are included in FIG. 21 and may be set forth as Time 1^{st} A2(n)>[Time B2(n)+Tperiod/2] and Time 1^{st} A2(n)<[Time B2(n)+3*Tperiod/4−2*Tdelay]. The third “specific timing requirement” may be set forth as approximately, Time 2^{nd} A2(n)=[Timelst A2(n)+Tperiod/4].

In the example of FIG. 21, since Mode 12 is a symmetrical mode, the commands B2 and both A2s may imply functions to take place at a time Tperiod/2 across the timing circle from the point at which the commands B2 and both A2s were actually received.

For symmetrical operational modes, we may assume that most, if not all, the images may have substantially the same period, duty, and phase alignment. This allows us to determine the approximate timing for the images with just one period, duty, and phase being communicated with the commands. Separate operational modes may be used for asymmetrical image periods and duties which will be or have been discussed in further detail.

FIG. 22 is a schematic diagram of another embodiment of a timing diagram. Similar to FIGS. 20 and 21, FIG. 22 illustrates two modes, Mode 11 and Mode 12, in the form of a timing diagram. The timing diagram 2200 of Mode 11 illustrates the shutter timing and includes many of the same descriptive elements as the timing circle 2000 of FIG. 20. For example, FIG. 22 includes the approximate time periods for functions that occur in the symmetrical dual 3D mode. More specifically, FIG. 22 includes similar time periods, Tduty, Tperiod, Tclose-both1, Topen-left1, Tclose-both2, Topen-righ1, Tclose-both3, Topen-left2, Tclose-both4, Topen-right2, and so on. Furthermore, FIG. 22 includes shutter eyewear 2203a and 2203b, 2205a and 2205b, 2207a and 2207b, and 2209a and 2209b, which depict multiple pairs of eyewear with both shutters closed or eyewear with either the left or the right shutter open.

Shutter eyewear 2203a and 2203b appears in FIG. 22 with both left and right shutters closed in a time period analogous to section 2020 of FIG. 20. Likewise, shutter eyewear 2205a and 2205b of FIG. 22 is depicted with eyewear 2205a with the left lens open and the right lens closed and eyewear 2205b with both shutters closed, and these eyewear appear in a time period analogous to section 2022 of FIG. 20, and so on.

FIG. 22 depicts shutter eyewear 2203a, 2205a, 2207a, and 2209a for a view 1 and shutter eyewear 2203b, 2205b, 2207b, and 2209b for a view 2. Left view 1 of FIG. 22 may view an Image 1 in section 2022 of FIG. 20 and right view 1 of FIG. 22 may view an Image 2 in section 2026 of FIG. 20. Left view 2 of FIG. 22 may view an Image 3 in section 2050 of FIG. 20 and right view 2 of FIG. 22 may view an Image 4 in section 2092 of FIG. 20. A similar logic may apply between FIGS. 21 and 22 for the timing circle 2100 of FIG. 21 and the timing diagram 2250 of FIG. 22.

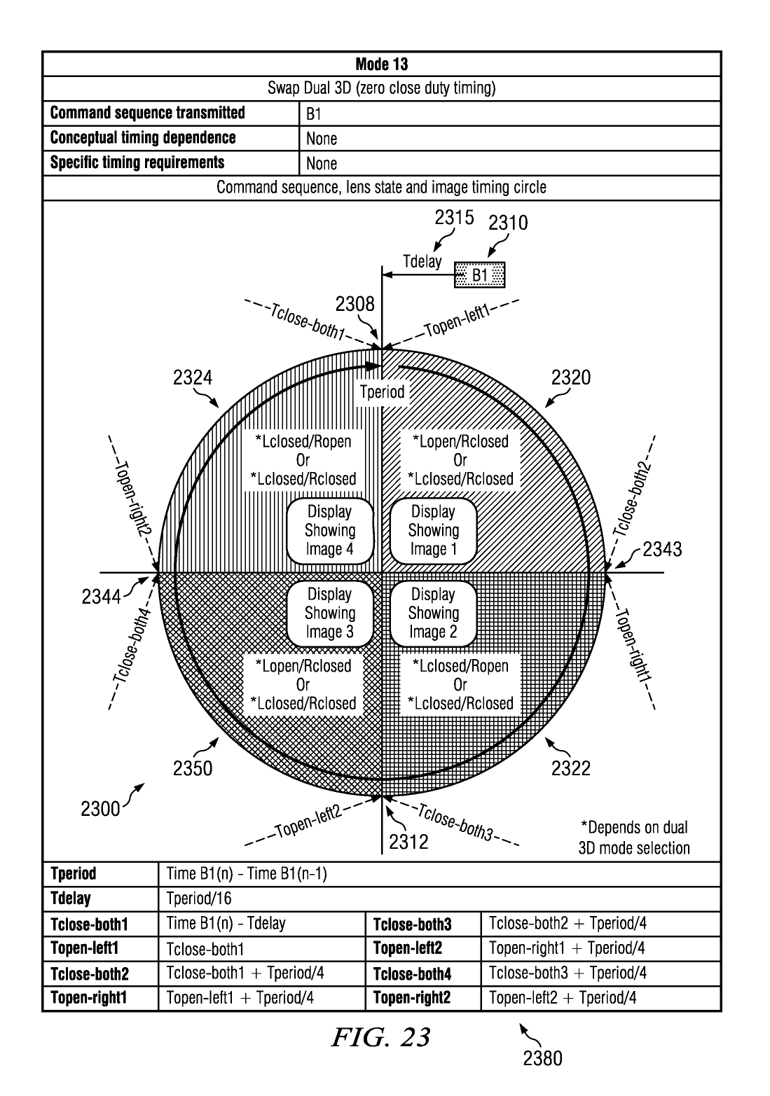

FIG. 23 is a schematic diagram of another embodiment of an image timing circle 2300 and Mode 13, which may be specified by the command sequence B1 and the timing locations as shown in FIG. 23. Mode 13 may also be referred to herein as swap dual 3D (zero close duty timing) mode. As shown in FIG. 23, command B1 2310 is illustrated at approximately the 12:00 position of the timing circle 2300. Command B1 2310 may be received by shutter eyewear (not shown in FIG. 23) and both the left and right shutters may close as illustrated by section 2320 for a period of time. No other commands may be received until command B1 2310 may be received again. Once the command B1 2310 may be received again, in the second cycle by shutter eyewear an operating mode may be determined.

Although periods of time, 2322, 2350, and 2324 may have elapsed, because an operating mode may not yet be determined, the left and right shutters may remain in an initial shuttering position through the sections 2322, 2350, and 2324 for at least the first cycle of the timing circle 2300. The initial shuttering position may be a left shutter open and a right shutter closed or both shutters close, depending on the dual 3D mode selection. After the shutter eyewear receives the command B2 2310 for a couple of cycles, in which the command is received in a substantially stable manner and spaced in time as illustrated by the timing circle 2300, the shutter eyewear may determine a mode of operation. Once the operating mode is determined, then a symmetric B1 point 2312, also labeled Tclose-both3 and Topen-left2, may be implied across the timing circle at approximately the 6:00 position. At implied B1 point 2312, again although no additional command may be received, the shuttering position may switch for the section 2350. The B1 command may have three symmetric implied commands all of which may be separated by approximately ¼ Tperiod. These commands may be are implied substantially similarly as the command at the 6:00 position.

Continuing the discussion of FIG. 23, command B1 2110 may be received after the B1 point 2308, also labeled Tclose-both1 and Topen-left1, where the shuttering action may take place. Although the B1 point 2308 may be the point at which the shuttering action occurs, the command B1 2310 may not be received until a Tdelay 2315 time period elapses following the B1 point 2308. Stated differently, although the command B1 2310 may not have been received, the operating mode may allow the shuttering action to be implied before the command may actually be received.

The table 2380 is also shown in FIG. 23. The table 2380 includes approximate time periods for functions that occur in the swap dual 3D (zero close duty timing) mode and demonstrates that the time periods for functions may depend on the relative timing locations. As shown in FIG. 23, Tperiod may be approximately the Time B(n)−Time B1 (n−1). Stated differently, Tperiod may be approximately the time between receiving a first command B1 and a second command B1. Also in table 2380, Tdelay may be approximately Tperiod/16. Furthermore, both the right and left shutter may be at an initial shuttering position at a 12:00 position, or as labeled on the timing circle 2300 the Tclose-both1 position 2308. This first position in time may be defined approximately by the time at which the B1 command 2310 is received minus the Tdelay 2315. Additionally, at the approximate 12:00 position, Topen-left1 may occur at substantially the same time as or slightly after the point 2308 to Tclose-both1 may be approximately set forth in table 2380 as the time Tclose-both1. The second position 2343 or labeled as Tclose-both2 on the timing circle 2300 may be the time at which the left shutter may close and the right shutter may open or both shutters close, depending on the dual 3D mode selection. The second position may be approximately the time at which Tclose-both1 position occurs plus Tperiod/4. Additionally, at the approximate 3:00 position, Topen-right1 may occur at substantially the same time as or slightly after the point 2343 or in other words, Topen-right1 may be approximately set forth in table 2380 as the time Topen-left1 plus Tperiod/4. The third position 2312 on the timing circle 2300, also labeled as Tclose-both3 at the 6:00 position, may be approximately the time at which the Tclose-both2 position occurs plus Tperiod/4. Additionally, at the approximate 6:00 position, Topen-left2 may occur at substantially the same time as or slightly after the point 2312 or in other words, Topen-left2 may be approximately set forth in table 2380 as the time Topen-right1 plus Tperiod/4.

The fourth position 2344 on the timing circle 2300 also labeled as Tclose-both4 may be approximately the time at which the right shutter may open and the left shutter may close or both shutters close, depending on the dual 3D mode selection. The fourth position may be approximately the time at which the third command Tclose-both3 occurs plus Tperiod/4. Additionally, at the approximate 9:00 position, Topen-right2 may occur at substantially the same time as or slightly after the point 2344 or in other words, Topen-right2 may be approximately set forth in table 2380 as the time Topen-left2 plus Tperiod/4.

Still continuing with FIG. 23, the conceptual timing dependence and the “specific timing requirements” for the swap dual 3D (zero close duty timing) may not be set forth. As previously mentioned, conceptual timing dependence generally illustrates the dependence of the mode on the type of command received as well as the time at which it was received.

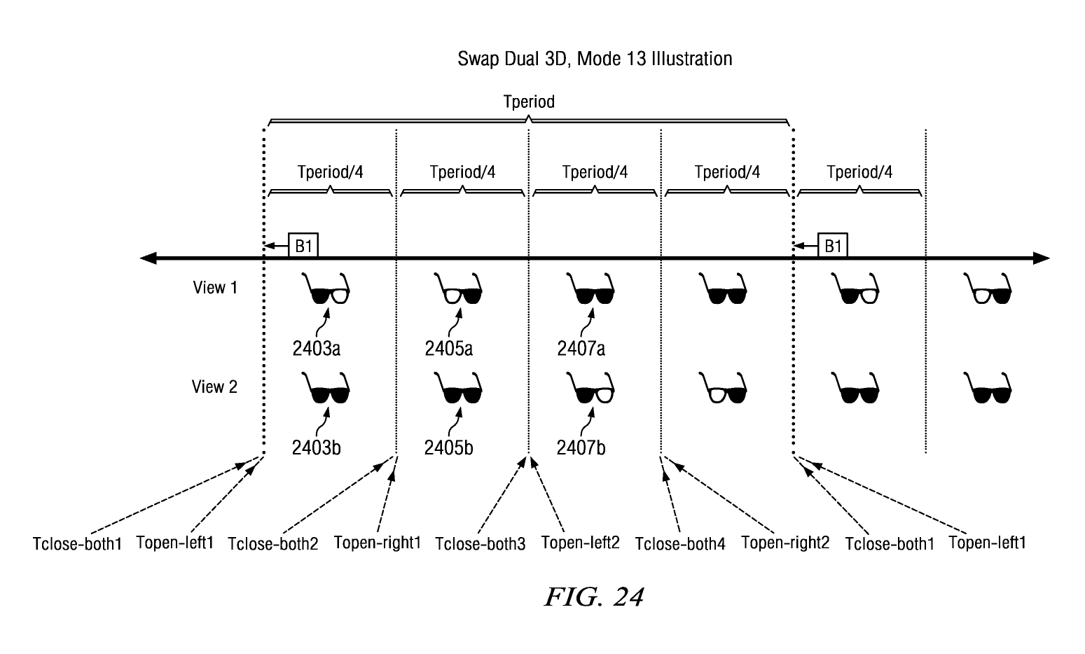

FIG. 24 is a schematic diagram of another embodiment of a timing diagram. Similar to FIG. 23, FIG. 24 illustrates Mode 13, except in the form of a timing diagram. The timing diagram 2400 of Mode 13 illustrates the shutter timing and includes many of the same descriptive elements as the timing circle 2300 of FIG. 23. For example, FIG. 24 includes the approximate time periods for functions that occur in the swap dual 3D mode (zero close duty timing). More specifically, FIG. 24 includes Tperiod, Tclose-both1, Topen-left1, Tclose-both2, Topen-right1, Tclose-both3, Topen-left2, Tclose-both4, Topen-right2, and so on. Furthermore, FIG. 24 includes shutter eyewear 2403a and 2402b, 2405a and 2405b, and 2407a and 2407b, which depict one pair of eyewear with both the left and right shutters closed together and another pair of eyewear with either the left or right shutter open and the other shutter closed, depending on the dual 3d mode selection. Shutter eyewear 2403a and 2403b appears in FIG. 24 in a time period analogous to section 2320 of FIG. 23. Likewise, shutter eyewear 2405a and 2405b appears in a time period in FIG. 24 analogous to section 2322 of FIG. 23, shutter eyewear 2407a and 2407b appears in a time period in FIG. 24 analogous to section 2350 of FIG. 23, and so on.

FIG. 24 depicts shutter eyewear 2403a, 2405a, and 2407a, for a view 1 and shutter eyewear 2403b, 2405b, and 2407b, for a view 2. Left view 1 of FIG. 24 may view an Image 1 in section 2320 of FIG. 23 and right view 1 of FIG. 24 may view an Image 2 in section 2322 of FIG. 23, and so on.

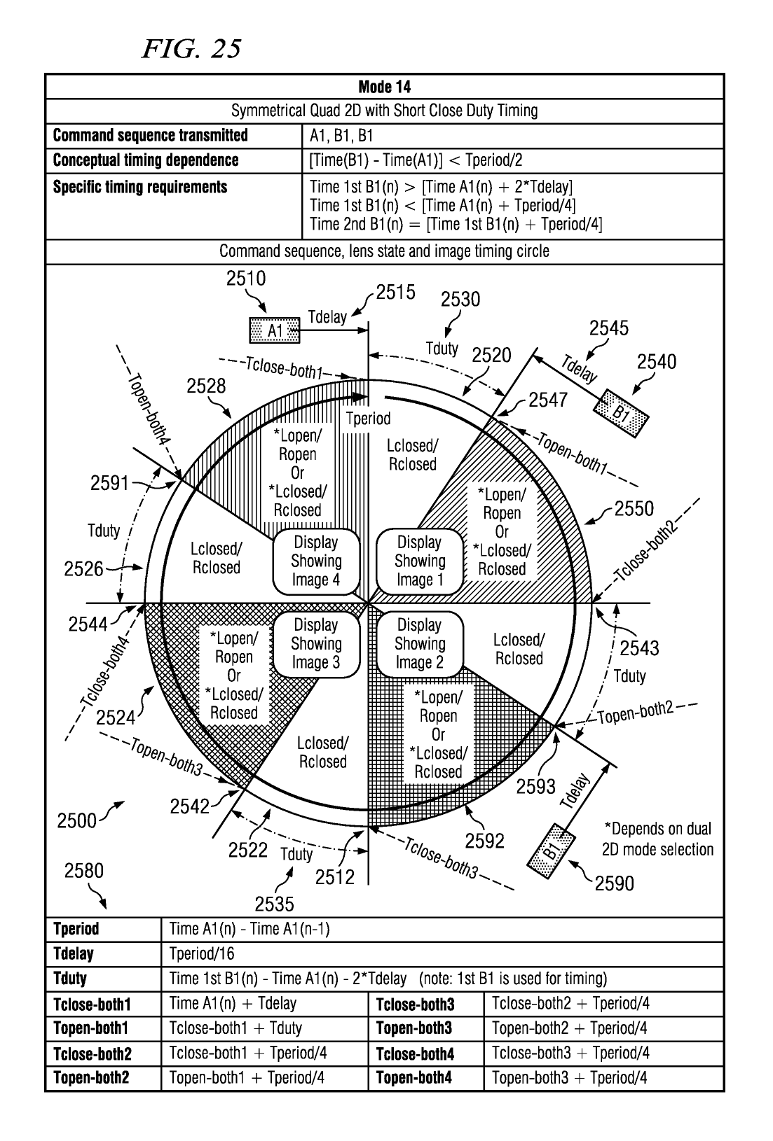

FIG. 25 is a schematic diagram of another embodiment of an image timing circle 2500 and Mode 14, which may be specified by the command sequence A1, B1, B1 and the timing locations as shown in FIG. 25. Mode 14 may also be referred to herein as symmetrical quad 2D with short close duty timing. As shown in FIG. 25, command A1 2510 is illustrated at approximately the 12:00 position of the timing circle 2500. After command A1 2510 may be received by shutter eyewear (not shown in FIG. 25) and a time of Tdelay 2515 may elapse, both the left and right shutters may close as illustrated by section 2520 for a period of time, Tduty 2530. Next, command B1 2540 may be received by shutter eyewear and is illustrated at approximately the 1:00 position of the timing circle 2500. The both shutters may open or may close, depending on the quad 2D mode selection, and an Image 1 may be viewed by both shutters for a period of time illustrated by section 2550. Furthermore, because command B1 2540 occurs between the 12:00-6:00 positions of the timing circle 2500, the operating mode may be 2D. Next, a second command B1 2590 may be received by shutter eyewear and is illustrated at approximately the 4:00 position of the timing circle 2500. Both shutters may open or close, depending on the quad 2D mode selection, and an Image 2 may be viewed through both shutters for a period of time illustrated by section 2592.

Although periods of time, 2522, 2524, 2526, 2528 may have elapsed, because an operating mode may not yet have been determined, the left and right shutters may remain closed through the sections 2522, 2524, 2526, and 2528 for at least the first cycle of the timing circle 2500. After the shutter eyewear receives the commands A1 2510, B1 2540, and B1 2590 for a couple of cycles, in which the commands are substantially stable and spaced in time as illustrated by the timing circle 2500, the shutter eyewear may determine a mode of operation. Once the operating mode is determined, then a symmetric B1 point 2542, also labeled Topen-both3, may be implied across the timing circle. Stated differently, at B1 point 2542, no additional command may be received, however both shutters may open or close, depending on the quad 2D mode selection, for the section 2524. Further, a symmetric A1 point 2512, also labeled Tclose-both3, may be implied across the timing circle at the 6:00 position. At A1 point 2512, again although no additional command may be received, the left and right shutter may close for the section 2522 for a time period of Tduty 2535. Moreover, a second symmetric B1 point 2591, also labeled Topen-both4, may be implied across the timing circle at approximately the 10:00 position. At B1 point 2191, again although no additional command may be received, both shutters may open or close depending on the quad 2D mode selection, for the section 2528. The A1 command may have three symmetric implied commands all of which may be separated by approximately ¼ Tperiod. These may be implied substantially similarly as the command at the 6:00 position. Since these are quad image commands, conceptually each B1 command may also have three symmetric implied commands. Two B1 commands may be used to distinguish this mode from dual 2D.

Continuing the discussion of FIG. 25, command B1 2540 may be received after the B1 point 2547, also labeled Topen-both1, where the shuttering action may take place. Although the B1 point 2547 may be the point at which the shuttering action occurs, the command B1 2540 may not be received until a Tdelay 2545 time period elapses following the B1 point 2547. Stated differently, although the command B1 2540 may not have been received, the operating mode may allow the shuttering action to be implied before the command may actually be received. Similar logic may apply to the second B1 command 2590.

The table 2580 is also shown in FIG. 25. The table 2580 includes approximate time periods for functions that occur in the symmetrical quad 2D with short close duty timing mode and demonstrates that the time periods for functions may depend on the relative timing locations relative. As shown in FIG. 25, Tperiod may be approximately the Time A1(n)−Time A1(n−1). Stated differently, Tperiod may be approximately the time between receiving a first command A1 and a second command A1. Also in table 2580, Tdelay may be approximately Tperiod/16. Furthermore, both the right and left shutter may close at a 12:00 position, or as labeled on the timing circle 2500 the Tclose-both1 position. This first position in time may be defined approximately by the time at which the A1 command 2010 is received plus the Tdelay 2515. The second position 2547 or labeled as Topen-both1 on the timing circle 2500 may be the time at which the left and right shutters may both open or close, depending on the quad 2D mode selection. The second position may be approximately the time at which Tclose-both1 position occurs plus Tduty 2530. The third position 2543 on the timing circle 2500, also labeled as Tclose-both2 at the 3:00 position, may be approximately the time at which the Tclose-both1 position occurs plus Tperiod/4. The fourth position 2593 on the timing circle 2500 also labeled as Topen-both2 may be approximately the time at which the right and left shutter may open or close, depending on the quad 2D mode selection. The fourth position may be approximately the time at which the second command Topen-both1 occurs plus Tperiod/4. The fifth position 2512 on the timing circle 2500, also labeled as Tclose-both3 at the 6:00 position, may be approximately the time at which the Tclose-both2 position occurs plus Tperiod/4. The sixth position 2542 on the timing circle 2500 also labeled as Topen-both3 may be approximately the time at which the left and right shutter may both open or close, depending on the quad 2D mode selection. The sixth position 2542 may be approximately the time at which the fourth command Topen-both2 occurs plus Tperiod/4. The seventh position 2544 on the timing circle 2500, also labeled as Tclose-both4 at the 9:00 position, may be approximately the time at which the Tclose-both3 position occurs plus Tperiod/4. The eighth position 2591 on the timing circle 2500 also labeled as Topen-both4 may be approximately the time at which the right and left shutter may both close or open, depending on the quad 2D mode selection. The eighth position 2591 may be approximately the time at which the sixth command Topen-both3 occurs plus Tperiod/4. Tduty may be set forth for Mode 14 as Time 1^{st} B1(n)−A1(n)−2*Tdelay, and 1^{st} B1 may be used for timing.

Still continuing with FIG. 25, the conceptual timing dependence for the symmetrical quad 2D with short close duty timing mode is approximately set forth. The conceptual timing dependence for this mode may be set forth such that [Time B1(n)−Time A1(n)]<Tperiod/2. As previously mentioned, the B1 command may be received between the 12:00-6:00 positions of the timing circle 2500 and the conceptual timing dependence illustrates the dependence of the mode on the type of command received as well as the time at which it was received. Additionally, the “specific timing requirements” for Mode 14 are included in FIG. 25 and may be set forth as Time 1^{st} B1(n)>[Time A1(n)+2*Tdelay] and Time 1^{st} B1(n)<[Time A1(n)+Tperiod/4]. The third “specific timing requirement” may be set forth as, Time 2^{nd} B1(n)=[Time1st B1(n)+Tperiod/4].

In the example of FIG. 25, since Mode 14 is a symmetrical mode, the commands A1 and both B1s may imply functions to take place at a time Tperiod/2 across the timing circle from the point at which the commands A1 and both B1s were actually received. Additionally, because the first B1 command arrives between the 12:00-6:00 positions on the timing circle, thus the operating mode may be in 2D. Moreover, the short close duty timing may be indicated by looking to the locations of the Tdelay time periods. As first command B1 2540 moves closer in time clockwise to implied command A1 at 6:00, keeping in mind B1 may stay between 12:00-6:00 on the timing circle, commands A1 and B1 may be minimally separated in time by at least 2*Tdelay. However, as command B1 2540 moves closer in time to the 12:00 position counterclockwise on the timing circle, Tduty 2530 may become smaller and may not be limited by the Tdelay times associated with the commands in the command sequence. In one example of Mode 14, Tduty 2530 may be smaller than the duration of a single Tdelay time. Since all except the single command modes may have two timing methods, long and short closed duty, there may no longer be any “holes” in the duty due to the Tdelay times that accompany the commands and period options due to command timing restrictions.

For symmetrical operational modes, we may assume that most, if not all, the images may have substantially the same period, duty, and phase alignment. This allows us to determine the approximate timing for the images with just one period, duty, and phase being communicated with the commands. Separate operational modes may be used for asymmetrical image periods and duties which will be or have been discussed in further detail.

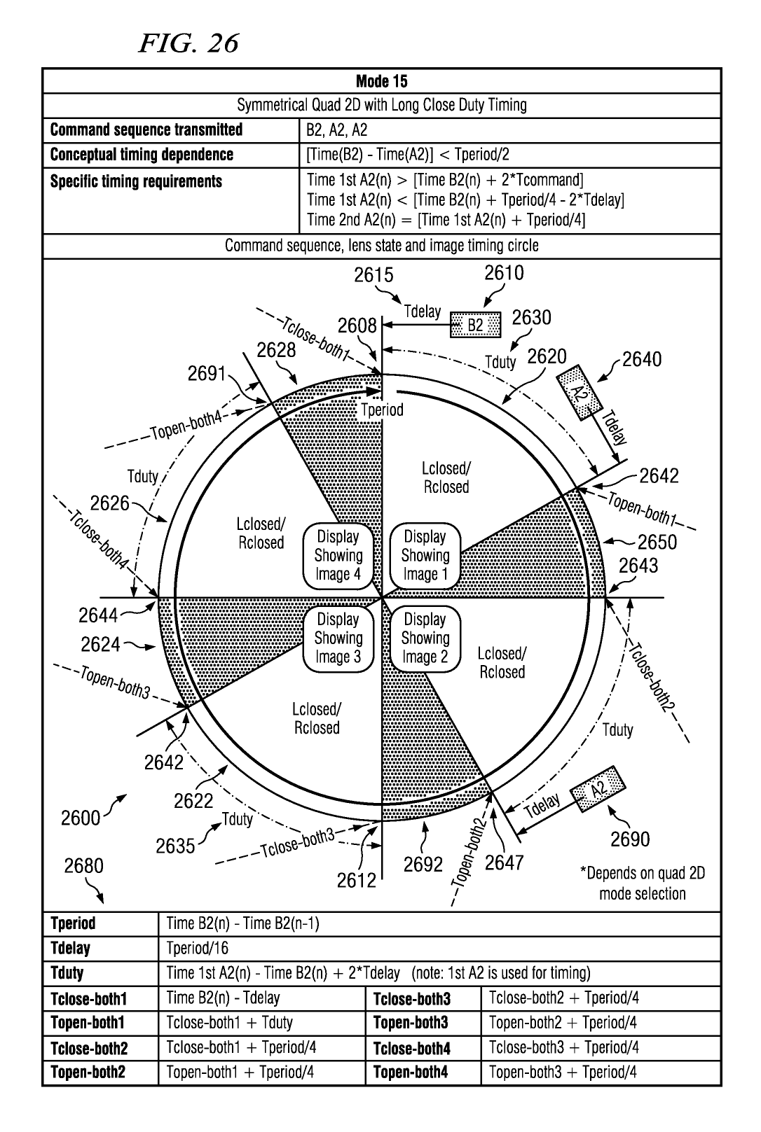

FIG. 26 is a schematic diagram of another embodiment of an image timing circle 2600 and Mode 15, which may be specified by the command sequence B2, A2, A2 and the timing locations as shown in FIG. 26. Mode 15 may also be referred to herein as symmetrical quad 2D with long close duty timing. As shown in FIG. 26, command B2 2610 is illustrated at approximately the 12:00 position of the timing circle 2600. After command B2 2610 may be received by shutter eyewear (not shown in FIG. 26) and both the left and right shutters may close as illustrated by section 2620 for a period of time, Tduty 2630. Next, command A2 2640 may be received by shutter eyewear and is illustrated at approximately the 2:00 position of the timing circle 2600. The left shutter and right shutter may open or close, depending on the quad 2D mode selection, and an Image 1 may be viewed through both the left and right shutters (or not viewed if in the opposite mode) for a period of time illustrated by section 2650. Next, a second command A2 2690 may be received by shutter eyewear and is illustrated at approximately the 5:00 position of the timing circle 2600. The left and right shutters may close or open, depending on the quad 2D mode selection, and an Image 2 may be viewed through both the left and right shutters (or not viewed if in a different mode), for a period of time illustrated by section 2692.

Although periods of time, 2622, 2624, 2626, 2628 may have elapsed, because an operating mode may not have yet been determined, the left and right shutters may remain in the shuttering state determined by the second A2 command 2690, through the sections 2622, 2624, 2626, and 2628 for at least the first cycle of the timing circle 2600. After the shutter eyewear receives the commands B2 2610, A2 2640, and A2 2690 for a couple of cycles, in which the commands are substantially stable and spaced in time as illustrated by the timing circle 2600, the shutter eyewear may determine a mode of operation. Once the operating mode is determined, then a symmetric A2 point 2642, also labeled Topen-both3, may be implied across the timing circle. Stated differently, at implied A2 point 2642, no additional command may be received, however the left and right shutters may open or close, depending on the quad 2D mode selection, for the section 2624. Further, a symmetric implied B2 point 2612, also labeled Tclose-both3, may be implied across the timing circle at the 6:00 position. At implied B2 point 2612, again although no additional command may be received, the left and right shutter may close for the section 2622 for a time period of Tduty 2635. Moreover, a second symmetric A2 point 2691, also labeled Topen-both4, may be implied across the timing circle at approximately the 11:00 position. At implied A2 point 2691, again although no additional command may be received, the left and right shutters may close or open, depending on the quad 2D mode selection, for the section 2628. The B2 command may have three symmetric implied commands all of which may be separated by approximately ¼ Tperiod. These may be implied substantially similarly as the command at the 6:00 position. Since these are quad image commands, conceptually each A2 command may also have three symmetric implied commands. Two A2 commands may be used to distinguish this mode from dual 2D.

Continuing the discussion of FIG. 26, command B2 2610 may be received after the point 2608, also labeled Tclose-both1, where the shuttering action may take place. Although the point 2608 may be the point at which the shuttering action occurs, the command B2 2610 may not be received until a Tdelay 2615 time period elapses following the point 2608. Stated differently, although the command B2 2610 may not have been received, the operating mode may allow the shuttering action to be implied before the command may actually be received.

The table 2680 is also shown in FIG. 26. The table 2680 includes approximate time periods for functions that occur in the symmetrical quad 2D with long close duty timing mode and demonstrates that the time periods for functions may depend on the relative timing locations relative. As shown in FIG. 26, Tperiod may be approximately the Time B2(n)−Time B2 (n−1). Stated differently, Tperiod may be approximately the time between receiving a first command B2 and a second command B2. Also in table 2680, Tdelay may be approximately Tperiod/16. Furthermore, both the right and left shutter may close at a 12:00 position, or as labeled on the timing circle 2600 the Tclose-both1 position 2608. This first position in time may be defined approximately by the time at which the B2 command 2610 is received minus the Tdelay 2615. The second position 2642 or labeled as Topen-both1 on the timing circle 2600 may be the time at which the left and right shutter may both open or close, depending on the quad 2D mode selection. The second position may be approximately the time at which Tclose-both1 position occurs plus Tduty 2630. The third position 2643 on the timing circle 2600, also labeled as Tclose-both2 at the 3:00 position, may be approximately the time at which the Tclose-both1 position occurs plus Tperiod/4. The fourth position 2647 on the timing circle 2600 also labeled as Topen-both2 may be approximately the time at which the left and right shutter may close or open, depending on the quad 2D mode selection. The fourth position may be approximately the time at which the second command Topen-both1 occurs plus Tperiod/4. The fifth position 2612 on the timing circle 2600, also labeled as Tclose-both3 at the 6:00 position, may be approximately the time at which the Tclose-both2 position occurs plus Tperiod/4. The sixth position 2642 on the timing circle 2600 also labeled as Topen-both 3 may be approximately the time at which the left and right shutter may open or close, depending on the quad 2D mode selection. The sixth position 2642 may be approximately the time at which the fourth command Topen-both2 occurs plus Tperiod/4. The seventh position 2644 on the timing circle 2600, also labeled as Tclose-both4 at the 9:00 position, may be approximately the time at which the Tclose-both3 position occurs plus Tperiod/4. The eighth position 2691 on the timing circle 2600 also labeled as Topen-both4 may be approximately the time at which the left and right shutters may close or open, depending on the quad 2D mode selection. The eighth position 2691 may be approximately the time at which the sixth command Topen-both3 occurs plus Tperiod/4. Furthermore, Tduty may be an approximate time Time 1^{st} A2(n)−Time B2(n)+2*Tdelay, noting that the first A2 command may be used for timing.

Still continuing with FIG. 26, the conceptual timing dependence for the symmetrical quad 2D with long close duty timing mode is approximately set forth. The conceptual timing dependence for Mode 15 may be set forth such that [Time B2(n)−Time A2(n)]<Tperiod/2. As previously mentioned, conceptual timing dependence may illustrate the dependence of the mode on the type of command received as well as the time at which it was received. Additionally, the “specific timing requirements” for Mode 15 are included in FIG. 26 and may be set forth as Time 1^{st} A2(n)>[Time B2(n)+2*Tcommand] and Time 1^{st} A2(n)<[Time B2(n)+Tperiod/4−2*Tdelay]. The third “specific timing requirement” may be set forth as approximately, Time 2^{nd} A2(n)=[Time1st A2(n)+Tperiod/4]. Tcommand may be the command timing and may be the transit time for each command, which may be approximately equal relative to whether short or long encoding may be selected. Further the actual transit time may be approximately 305 microseconds for short command encoding and approximately 1220 microseconds for long command encoding.

In the example of FIG. 26, since Mode 15 is a symmetrical mode, the commands B2 and both A2s may imply shuttering functions to take place at an approximate time Tperiod/2 across the timing circle from the point at which the commands B2 and both A2s were actually received.

For symmetrical operational modes, we may assume that most, if not all, the images may have substantially the same period, duty, and phase alignment. This allows us to determine the approximate timing for the images with just one period, duty, and phase being communicated with the commands. Separate operational modes may be used for asymmetrical image periods and duties which will be or have been discussed in further detail.

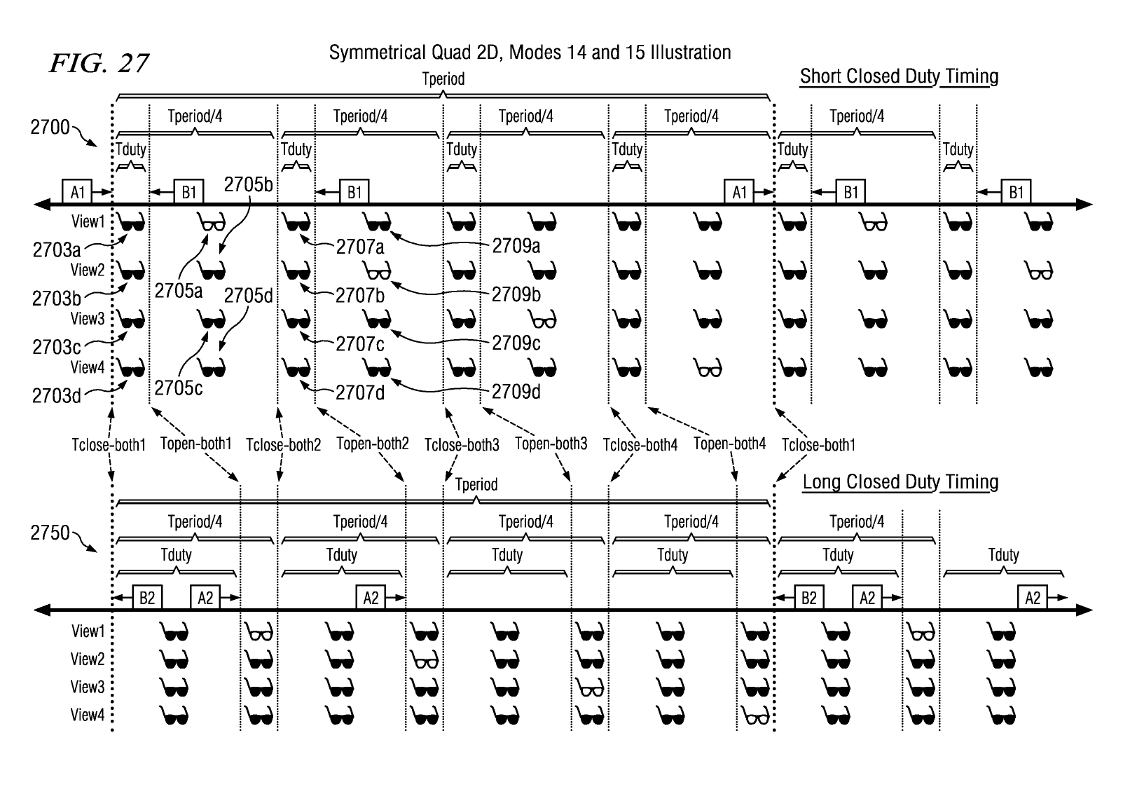

FIG. 27 is a schematic diagram of another embodiment of a timing diagram. Similar to FIGS. 25 and 26, FIG. 27 illustrates two modes, Mode 14 and Mode 15, in the form of a timing diagram. The timing diagram 2700 of Mode 14 illustrates the shutter timing and includes many of the same descriptive elements as the timing circle 2500 of FIG. 25. For example, FIG. 27 includes the approximate time periods for functions that occur in the symmetrical quad 2D with short close duty timing mode. More specifically, FIG. 27 includes similar time periods, Tduty, Tperiod, Tclose-both1, Topen-both1, Tclose-both2, Topen-both2, Tclose-both3, Topen-both3, Tclose-both4, Topen-both4, and so on. Furthermore, FIG. 27 includes shutter eyewear 2703a, 2703b, 2703c and 2703d, 2705a, 2705b, 2705c, and 2705d, 2707a, 2707b, 2707c, and 2207d, and 2709a, 2709b, 2709c, and 2709d, which depict multiple pairs of eyewear with both shutters closed or open.

Shutter eyewear 2703a, 2703b, 2703c and 2703d, appears in FIG. 27 with all left and right shutters closed in a time period analogous to section 2520 of FIG. 25. Likewise, shutter eyewear 2705a, 2705b, 2705c, and 2705d of FIG. 27 are depicted with eyewear 2705a with both the left and right shutters open, and eyewear 2705b, 2705c, and 2705d with both shutters closed, and these eyewear appear in a time period analogous to section 2550 of FIG. 25, and so on.

FIG. 27 depicts shutter eyewear 2703a, 2705a, 2707a and 2709a for a view 1, shutter eyewear 2703b, 2705b, 2707b and 2709b for a view 2, shutter eyewear 2703c, 2705c, 2707c and 2709c for a view 3, and shutter eyewear 2703d, 2705d, 2707d and 2709d for a view 4. View 1 of FIG. 27 may view an Image 1 in section 2550 of FIG. 25 and View 2 of FIG. 27 may view an Image 2 in section 2592 of FIG. 25. A similar logic may apply between FIGS. 26 and 27 for the timing circle 2600 of FIG. 26 and the timing diagram 2750 of FIG. 27.

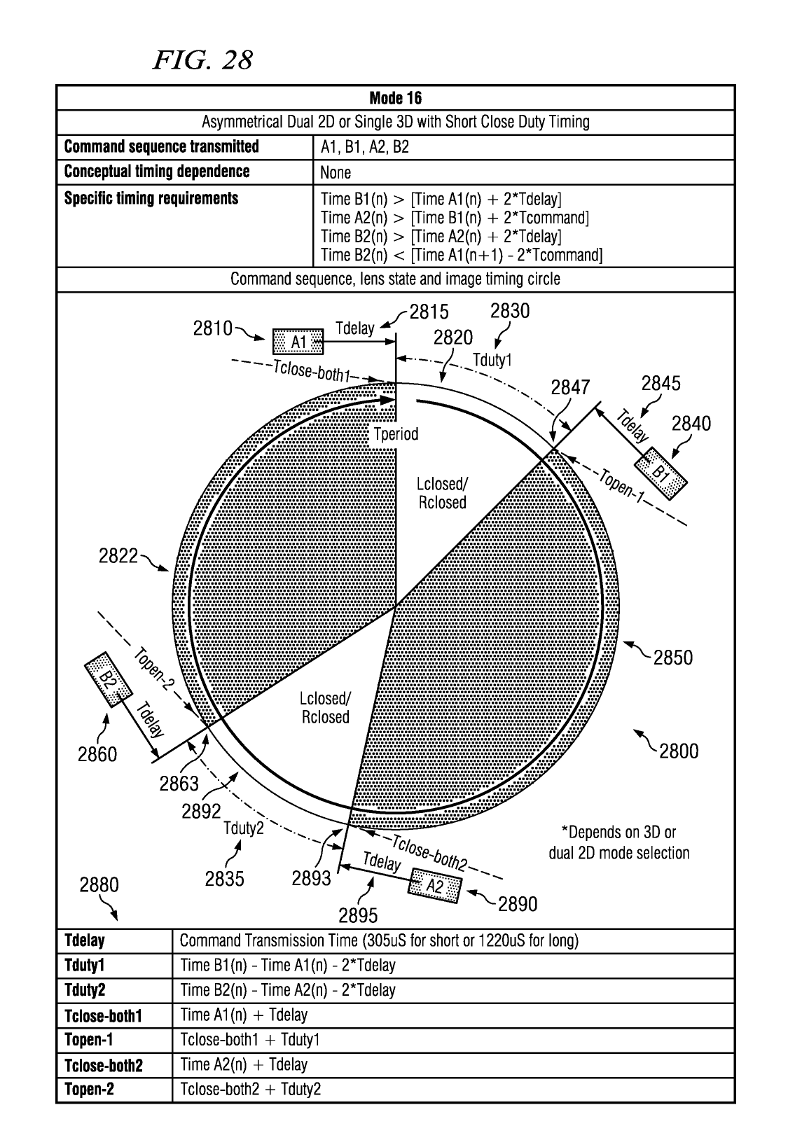

FIG. 28 is a schematic diagram of another embodiment of an image timing circle 2800 and Mode 16, which may be specified by the command sequence A1, B1, A2, B2 and the timing locations as shown in FIG. 28. Mode 16 may also be referred to herein as asymmetrical dual 2D or single 3D with short close duty timing. As shown in FIG. 28, command A1 2810 is illustrated at approximately the 12:00 position of the timing circle 2800. After command A1 2810 may be received by shutter eyewear (not shown in FIG. 28) and a time of Tdelay 2815 may elapse, both the left and right shutters may close as illustrated by section 2820 for a period of time, Tduty1 2830. Next, command B1 2840 may be received by shutter eyewear and is illustrated at approximately the 2:30 position of the timing circle 2800. The left shutter and right shutters may both open or close substantially together or the left shutter may open and the right shutter may close, depending on the 3D or dual 2D mode selection, and an Image 1 may be viewed for a period of time illustrated by section 2850.

Next, a second command A2 2890 may be received by shutter eyewear and is illustrated at approximately the 6:30 position of the timing circle 2800. Both the left and right shutter may close substantially together, for a period of time illustrated by section 2892, or Tduty2 2831.

A fourth command B2 2860 may be received by shutter eyewear and is illustrated at approximately the 8:00 position of the timing circle 2800. The left shutter may open and the right shutter may close, or both the left and right shutter may open or close substantially together, depending on the 3D or dual 2D mode selection, and an Image 2 may be viewed for a period of time illustrated by section 2822.

For the first couple of cycles, an operating mode may not be determined. However, after the shutter eyewear receives the commands A1 2810, B1 2840, A2 2890, and B2 2860 for a couple of cycles, in which the commands are substantially stable and spaced in time as illustrated by the timing circle 2800, the shutter eyewear may determine a mode of operation. Even though the operating mode may be determined, because Mode 16 is an asymmetric mode, other commands may not be implied across the timing circle.

Continuing the discussion of FIG. 28, command B1 2840 may be received after the B1 point 2847, also labeled Topen-1, where the shuttering action may take place. Although the B1 point 2847 may be the point at which the shuttering action occurs, the command B1 2840 may not be received until a Tdelay 2845 time period elapses following the B1 point 2847. Stated differently, although the command B1 2840 may not have been received, the operating mode may allow the shuttering action to be implied before the command may actually be received. Similar logic may apply to the second B2 command 2860.

The table 2880 is also shown in FIG. 28. The table 2880 includes approximate time periods for functions that occur in the Asymmetrical Dual 2D or single 3D with short close duty timing mode and demonstrates that the time periods for functions may depend on the relative timing locations relative. As shown in FIG. 28, Tdelay may be approximately the command transmission time which may be 350 microseconds for short close duty timing modes. Furthermore, both the right and left shutter may close at a 12:00 position, or as labeled on the timing circle 2800 the Tclose-both1 position. This first position in time may be defined approximately by the time at which the A1 command 2810 is received plus the Tdelay 2815. The second position 2847 or labeled as Topen-1 on the timing circle 2800 may be the time at which the left shutter may open and the right shutter may close or both left and right shutters may open or close, depending on the 3D or dual 2D mode selection. The second position may be approximately the time at which Tclose-both1 position occurs plus Tduty1 2830. The third position 2893 on the timing circle 2800, also labeled as Tclose-both2 at the 6:30 position, may be approximately the time at which the A2 command 2890 is received plus the Tdelay 2895. The fourth position 2863 on the timing circle 2800 also labeled as Topen-2 may be approximately the time at which third position occurs Tclose-both2 plus the period of time for Tduty2 2831. Tduty1 may be set forth for Mode 16 as Time B1(n)−Time A1(n)−2*Tdelay and Tduty 2 may be set forth as Time B2(n)−Time A2(n)−2*Tdelay.

Still continuing with FIG. 28, the conceptual timing dependence for the asymmetrical dual 2D or single 3D with short close duty timing mode may not be set forth. Additionally, the “specific timing requirements” for Mode 16 are included in FIG. 28 and may be set forth as Time B1(n)>[Time A1(n)+2*Tdelay] and Time A2(n)>[Time B1(n)+2*Tcommand]. The third “specific timing requirement” may be set forth as, Time B2(n)>[Time A2(n)+2*Tdelay] and the fourth “specific timing requirement” may be set forth as, Time B2(n)<[Time A1(n+1)−2*Tcommand].

In the example of FIG. 28, since Mode 16 is an asymmetrical mode, the commands A1, B1, A2 and B2 may not imply functions to take place at a time Tperiod/2 across the timing circle from the point at which the commands A1, B1, A2 and B2 were actually received.

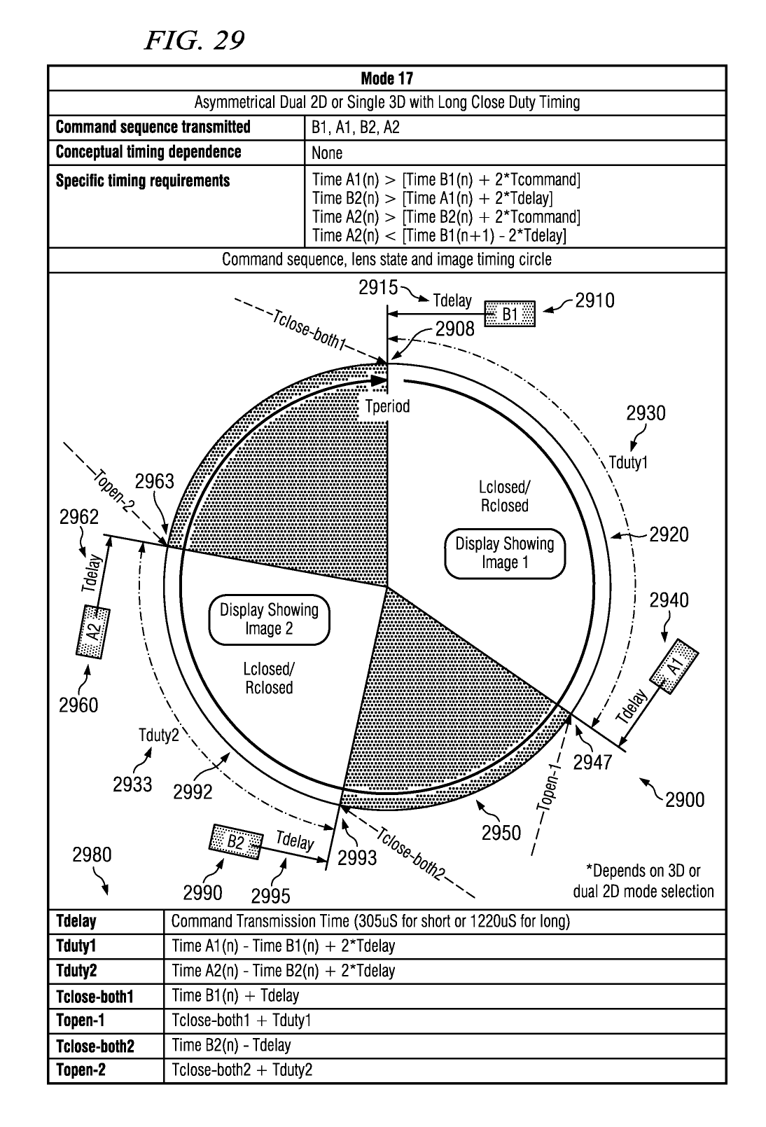

FIG. 29 is a schematic diagram of another embodiment of an image timing circle 2900 and Mode 17, which may be specified by the command sequence B1, A1, B2, A2 and the timing locations as shown in FIG. 29. Mode 17 may also be referred to herein as asymmetrical dual 2D or single 3D with long close duty timing. As shown in FIG. 29, command B1 2910 is illustrated at approximately the 12:00 position of the timing circle 2900. After command B1 2910 may be received by shutter eyewear (not shown in FIG. 29) and both the left and right shutters may close as illustrated by section 2920 for a period of time, Tduty1 2930. Next, command A1 2940 may be received by shutter eyewear and is illustrated at approximately the 4:00 position of the timing circle 2900. The left shutter may open and the right shutter may close or both shutters may open or close, depending on the 3D or dual 2D mode selection, and an Image 1 may be viewed for a period of time illustrated by section 2950. Next, a third command B2 2990 may be received by shutter eyewear and is illustrated at approximately the 6:30 position of the timing circle 2900. The left and right shutters may close for section 2992 or a period of time Tduty2 2933. Additionally, a fourth command A2 2960 may be received and after an approximate amount of time, Tdelay 2962, the left shutter may close and the right shutter may open, or both the shutters may open or close, depending on the 3D or dual 2D mode selected.

An operating mode may not be determined until after the shutter eyewear receives the commands B1 2910, A1 2940, B2 2990, and A2 2960 for a couple of cycles, in which the commands are substantially stable and spaced in time as illustrated by the timing circle 2900, the shutter eyewear may determine a mode of operation. Even though the operating mode may be determined, a symmetric point may not be implied at Tperiod/2 across the timing circle from the actual commands.

Continuing the discussion of FIG. 29, command B1 2910 may be received after the B1 point 2908, also labeled Tclose-both1, where the shuttering action may take place. Although the B1 point 2908 may be the point at which the shuttering action occurs, the command B1 2910 may not be received until a Tdelay 2915 time period elapses following the B1 point 2908. Stated differently, although the command B1 2910 may not have been received, the operating mode may allow the shuttering action to be implied before the command may actually be received.

The table 2980 is also shown in FIG. 29. The table 2980 includes approximate time periods for functions that occur in the asymmetrical dual 2D or single 3D with long close duty timing mode and demonstrates that the time periods for functions may depend on the relative timing locations relative. As shown in FIG. 29, Tdelay may be approximately the command transmission time which may be 1220 microseconds for a long close duty timing mode. Furthermore, both the right and left shutter may close at a 12:00 position, or as labeled on the timing circle 2900 the Tclose-both1 position 2908. This first position in time may be defined approximately by the time at which the B1 command 2910 is received minus the Tdelay 2915. The second position 2947 or labeled as Topen-1 on the timing circle 2900 may be the time at which the left shutter may open and the right shutter may close or both shutters may open or close, depending on the 3D or dual 2D mode selection. The second position may be approximately the time at which Tclose-both1 position occurs plus Tduty1 2930. The third position 2993 on the timing circle 2900, also labeled as Tclose-both2 at the 6:30 position, may be approximately the time at which the command B2 2990 may be received minus an approximate amount of time Tdelay 2995. The fourth position 2963 on the timing circle 2900 also labeled as Topen-2 may be approximately the time at which the right shutter may open and the left shutter may close or both shutters may open or close, depending on the 3D or dual 2D mode selection. The fourth position may be approximately the time at which the third position 2993 may take place plus the approximate amount of time Tduty2 2933. Tduty1 may be set forth as Time A1(n)−Time B1(n)+2*Tdelay with respect to Mode 17. Additionally, Tduty2 may be set forth as Time A2(n)−TimeB2(n)+2*Tdelay with respect to Mode 17.

Still continuing with FIG. 29, the conceptual timing dependence for the asymmetrical dual 2D or single 3D with long close duty timing mode may not be set forth for Mode 17. Additionally, the “specific timing requirements” for Mode 17 are included in FIG. 29 and may be set forth as approximately Time A1(n)>[Time B1(n)+2*Tcommand] and Time B2(n)>[Time A1(n)+2*Tdelay]. The third “specific timing requirement” may be set forth as approximately, Time A2(n)>[Time B2(n)+2*Tcommand]. Further, the fourth “specific timing requirement” may be set forth as approximately, Time A2(n)<[Time B1(n+1)−2*Tdelay]. Tcommand may be the command timing and may be the transit time for each command, which may be approximately equal relative to whether short or long encoding may be selected. Further the actual transit time may be approximately 305 microseconds for short command encoding and approximately 1220 microseconds for long command encoding.

In the example of FIG. 29, since Mode 17 is an asymmetrical mode, the commands B1, A1, B2 and A2 may not imply functions to take place at a time Tperiod/2 across the timing circle from the point at which the commands B1, A1, B2 and A2 were actually received.

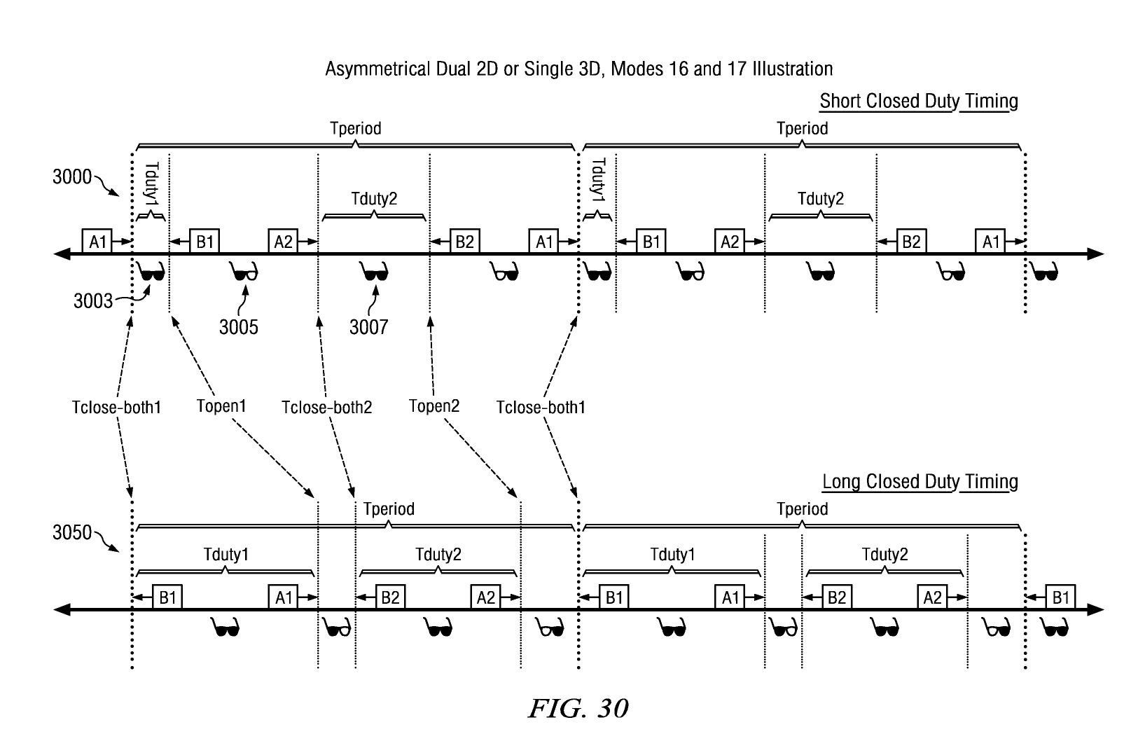

FIG. 30 is a schematic diagram of another embodiment of a timing diagram. Similar to FIGS. 28 and 29, FIG. 30 illustrates two modes, Mode 16 and Mode 17, in the form of a timing diagram. The timing diagram 3000 of Mode 16 illustrates the shutter timing and includes many of the same descriptive elements as the timing circle 2800 of FIG. 28. For example, FIG. 30 includes the approximate time periods for functions that occur in the asymmetrical dual 2D or single 3D mode. More specifically, FIG. 30 includes similar time periods, Tduty1, Tduty2, Tperiod, Tclose-both1, Topen-1, Tclose-both2, Topen-2, and so on. Furthermore, FIG. 30 includes shutter eyewear 3003, 3005, 3007, which depict multiple pairs of eyewear with both shutters open or closed, or eyewear with either the left or the right shutter open. Shutter eyewear 3003 appears in FIG. 30 in a time period analogous to section 2820 of FIG. 28. Likewise, shutter eyewear 3005 appears in FIG. 30 in a time period analogous to section 2850 of FIG. 28, shutter eyewear 3007 appears in FIG. 30 in a time period analogous to section 2892 of FIG. 28, and so on. Similarly, the timing diagram 3050 of FIG. 30 may represent the timing circle 2900 of FIG. 29 with similar logic applied.

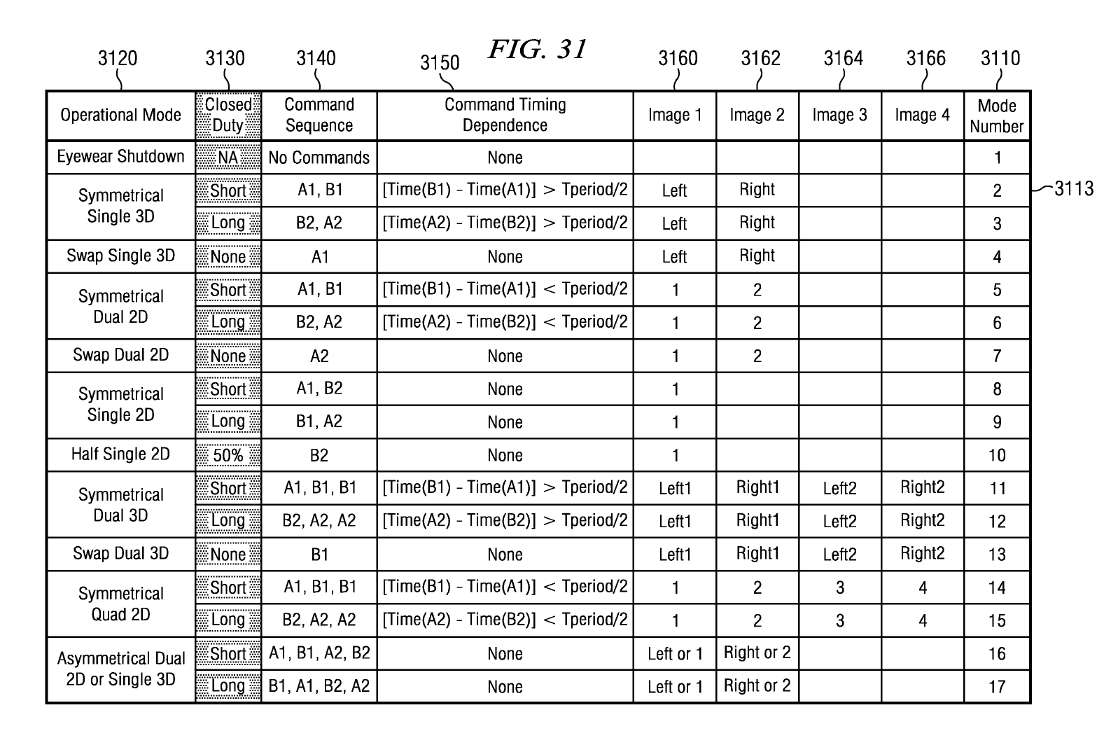

FIG. 31 is a summary table of the modes and mode descriptions. FIG. 31 is a command summary table of command sequences and modes of operation which may be determined based on command sequence and timing dependence. FIG. 31 includes column 3110, which lists the mode numbers, column 3120 is a short name of the operational mode, column 3130 is a description of whether the mode is short closed duty or long closed duty, column 3140 provides the commands included in the command sequence for the corresponding modes, column 3150 provides the command timing dependence, and columns 3160, 3162, 3164, 3166 provide Images 1, 2, 3 and 4, respectively and summarizes which modes utilize which images in the timing circles.

The mode numbers of column 3110 correspond to the mode numbers that have been utilized to describe the timing circles and timing diagrams herein, with the exception of Mode 1. Mode 1 is an eyewear shutdown mode in which there are no commands in the command sequence and no images being displayed as illustrated in FIG. 31.

In another example Mode 2 in line 3113, corresponds to Mode 2 of FIG. 5. Accordingly, the command sequences of Mode 2 in line 3113 and Mode 2 of FIG. 5, both include commands A1 and B1, utilize Image 1 and Image 2 and the command timing dependency of column 3150 of FIG. 31 and FIG. 5 are both set forth similarly as approximately [Time B1(n)−Time A1(n)]>Tperiod/2.

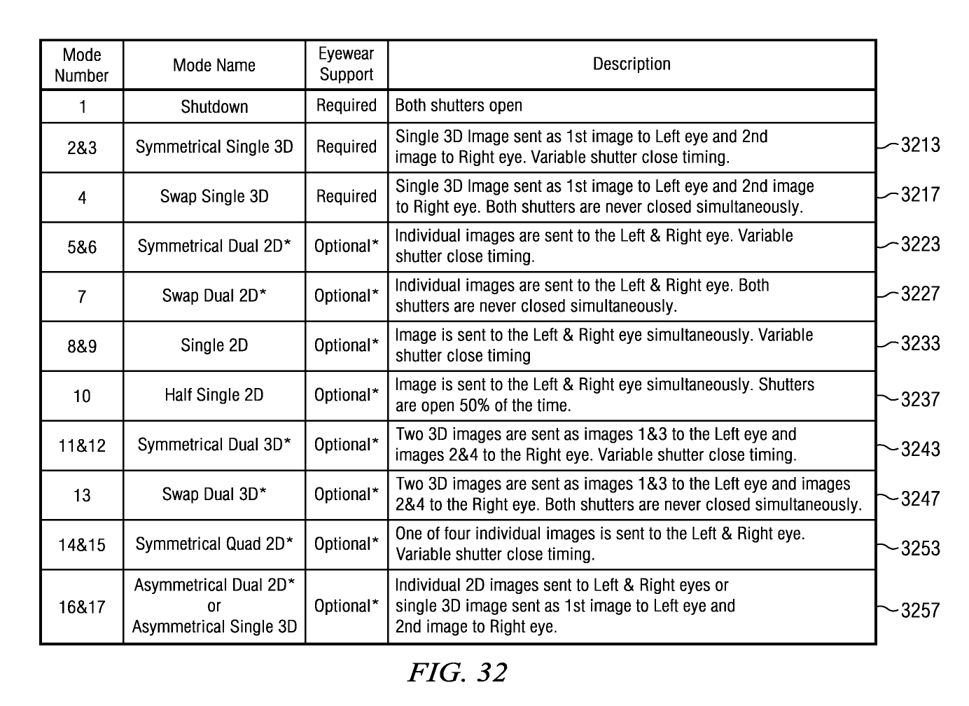

FIG. 32 is another summary table of modes and mode descriptions. Column 3210 includes the mode numbers, column 3220 includes the mode names, column 3230 includes the corresponding description of the mode number. The mode numbers of column 3210 correspond to the modes numbers described herein. For example, Mode 2 of line 3213 in FIG. 32 corresponds to Mode 2 of FIG. 5. With that said, FIG. 32 includes an additional short description of the operating mode. Continuing the example of line 3213 of Modes 2 and 3 of FIG. 32, column 3230 includes the short description that a single 3D image may be sent as a 1^{st} image to the left eye and the 2^{nd} image to the right eye. Additionally, Modes 2 and 3 may have variable shutter close timing.

In line 3217, Mode 4 is described in FIG. 32 as single 3d image sent as 1^{st} image to the left eye and the 2^{nd} image to the right eye. Further both shutters may not be closed simultaneously. Line 3223 includes a description of Modes 5 and 6 as individual images may be sent to the Left & Right eye and additionally Modes 5 and 6 may have variable shutter close timing.

In line 3227, Mode 7 is described in FIG. 32 may be described as individual images may be sent to the Left & Right eye. Further both shutters may not be closed simultaneously. Line 3233 includes a description of Modes 8 and 9 as an image may be sent to the Left & Right eye simultaneously and additionally, Modes 8 and 9 may have variable shutter close timing.

In line 3237, Mode 10 in FIG. 32 may be described as an image may be sent to the Left & Right eye substantially simultaneously. Further Shutters may be open approximately 50% of the time. Line 3243 includes a description of Modes 11 and 12 as two 3D images may be sent as images 1 &3 to the Left eye and images 2&4 to the Right eye and additionally, Modes 11 and 12 may have variable shutter close timing.

In line 3247, Mode 13 in FIG. 32 may be described as two 3D images may be sent as images 1&3 to the Left eye and images 2&4 to the Right eye. Further, both shutters not be closed substantially. Line 3253 includes a description of Modes 14 and 15 as one of four individual images may be sent to the Left & Right eye and additionally, Modes 14 and 15 may have variable shutter close timing.

In line 3257, Mode 17 in FIG. 32 may be described as individual 2D images may be sent to Left & Right eyes or single 3D image sent as 1^{st} image to Left eye and 2^{nd} image to Right eye.

Even though as previously discussed with respect to all operating modes herein, the operating mode may or may not be determined until after the same command sequence has been received at least a couple times, or two or more times, it is possible for the operating mode to be determined after the command sequence has only been received once.

In another embodiment, a receiving device may receive one or more signals and may determine an operating mode. Once the receiving device determines the operating mode, the receiving device may stop “looking for” a signal by turning off the receiver. The receiver may be turned off for any length of time and in one example, may be turned off for ⅓ of a second or approximately 333 milliseconds. By turning off the receiver of the receiving device, the receiving device may consume less power, thus increasing the battery life of the receiving device.

As may be used herein, the terms “substantially” and “approximately” provide an industry-accepted tolerance for its corresponding term and/or relativity between items. Such an industry-accepted tolerance ranges from less than one percent to ten percent and corresponds to, but is not limited to, component values, angles, et cetera. Such relativity between items ranges between less than approximately one percent to ten percent.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A method for conveying information to a receiver, the method comprising:
providing a command sequence, wherein the command sequence includes shutter timing information and the command sequence includes at least one command of a set of commands, wherein the commands indicate different functions depending on a timing location; and
enabling an emitter to emit a signal containing at least the command sequence.

2. The method of claim 1, wherein the commands indicate different functions depending on the order of the commands relative to one another.

3. The method of claim 1, wherein the commands indicate different functions depending on the quantity of each command included in the command sequence.

4. The method of claim 1, wherein the command sequence defines an operating mode for shutter eyewear, further wherein the operating mode may be assumed to be stable after at least two command sequences.

5. The method of claim 1, further comprising defining the time between lens actions and commands as a fraction of a lens sequence period.

6. The method of claim 1, wherein defining the time between lens actions and commands further comprises measuring the lens sequence period between the centers of commands for all but non-symmetric modes.

7. The method of claim 1, further comprising removing dependency on real time counting in the shutter timing information.

8. The method of claim 1, further comprising providing the signal as an infrared signal.

9. The method of claim 1, further comprising substantially removing timing holes in the duty cycle and period options due to command timing restrictions.

10. A method for receiving information from an emitter, the method comprising:
receiving a command sequence that includes shutter timing information, wherein the command sequence comprises at least one command of a set of commands, wherein the commands indicate different functions depending on a timing location and at least one command of the set of commands may be received after the function should occur; and
enabling a receiver to receive a signal including at least the command sequence.

11. The method of claim 10, wherein the commands indicate different functions depending on the order of the commands relative to one another within the command sequence.

12. The method of claim 10, wherein the commands indicate different functions depending on the quantity of each command included in the command sequence.

13. The method of claim 10, wherein the command sequence is received by shutter eyewear and the command sequences defines an operating mode for the shutter eyewear.

14. The method of claim 10, further comprising defining the time between lens actions and commands as a fraction of a lens sequence period.

15. The method of claim 10, wherein defining the time between lens actions and commands further comprises measuring the lens sequence period between the centers of commands for all but non-symmetric modes.

16. The method of claim 14, further comprising removing dependency on real time counting in the shutter timing information, wherein the lens sequence period is not a fixed time.

17. The method of claim 10, further comprising determining an operating mode after receiving more than two cycles of command sequences.

18. The method of claim 17, further comprising continuing the operating mode after determining the operating mode by assuming the operating mode will remain substantially stable.

19. A shutter timing protocol for conveying information, the shutter timing protocol comprising:
a set of commands wherein at least one of the commands may be received after the function should be performed;
a command sequence including at least one of the commands of the set of commands, wherein the commands indicate different functions to be performed depending on the quantity of each command within the command sequence and depending on the timing location of the command within the command sequence.

20. The shutter timing protocol of claim 19, wherein the command sequence substantially removes timing holes in the duty cycle and period options due to command timing restrictions.
